(19) United States
(12) Patent Application Publication
(10) Pub. No.: US 2010/0174610 A1
(43) Pub. Date: Jul. 8, 2010

(54) Internet-Based Personal Media Group Website Technology for Content Management and Exchange (System and Methods)

(76) Inventor: Alejandro Emilio Del Real, Delray Beach, FL (US)

Correspondence Address: Alejandro E. Del Real, 16328 Mira Vista Ln., Delray Beach, FL, 33446, US

(21) Appl. No.: 12/395,852

(22) Filed: Mar. 2, 2009

Related U.S. Application Data
(60) Provisional application No. 61/036,856, filed on Mar. 14, 2008.

(51) Int. Cl. G06F 17/30; G06Q 30/00

(52) U.S. Cl. 705/14.73; 707/784; 707/E17.005; 715/760; 715/752

(57) ABSTRACT

Internet Based System and Methods for implementing a Media Group Website Technology Platform for Content Management and Exchange by providing means for allowing: A1) The creation of the Personal Media Group comprised by: A1) A Community Website for Media Broadcasters (including Program/Channel Schedule), A2) A Community Website for Media Consumers, A3) Personal Media Portals for Media Consumers. B) The Communication within the Personal Media Group: B1) Among entity websites (Communities and Personal Media Portals), B2) To electronic mail via e-mail devices and/or text-messaging devices. These entity websites are independent Content Management Systems (CMS) reachable by their domain names. Each CMS includes their own security system and predefined pages for Media Content (Television, Radio, News Papers, Songs [Music], Movies, PC [Cloud Computer], Home [Virtual Home], Phone [Video Conferencing], etc.) delivered by Broadcasters. Each CMS is connected to the Personal Media Group (GCMS) allowing within the Management and Exchange of Media Content.

The present invention relates generally to systems and methods for the management and exchange of content (information) between individuals organized in a group context with the desire of shearing such content to anyone interested by having it totally or partially exposed to the internet and World Wide Web. More specifically, the present invention relates to systems and methods in which a Media Broadcaster (Producer and/or Distributor of Television, Radio, News Papers, Songs [Music], Movies, PC [Cloud Computer], Home Systems [Virtual Home], Phone Systems [Video Conferencing], etc.) and Consumer Group (from now on described as the Personal Media Group), manage and exchange media content and communication included but not limited to media programs and content (in the form of text, video and audio), media channel schedules content, advertisement content and notifications (emergency and standard) via a web portal accessed by a web browser, e-mail access by an e-mail device and text messaging access by a text messaging device within the Personal Media Group (mainly divided into Broadcasters [Media Producers and Distributors] and Consumers), by using an electronic network such as the Internet and World Wide Web and a group website technology development environment. The present invention also relates to the provision of an infrastructure that allows for on-line registration and subscription payments of Personal Media Portals (preconfigured website development environments or content management systems [CMS]) to include in the Personal Media Group (group content management and exchange system [GCMS]) as well as sponsors advertisement to be displayed in each Personal Media Portal (CMS) within the Personal Media Group (GCMS).

The Internet-Based Group Website Technology System 10000 according to FIG. 1 and FIG. 2 is comprised of the following components: 1) A Hosting Server Computers 12000: Where the Internet-Based Group Website Technology CORE System 19100 resides. The hosting servers manage the storage 18000 of the Personal Media Group content (information). These servers are connected to a network such as the Internet and World Wide Web. 2) A Hosting Server Software Platform (13000 to 18000): Where the Internet-Based Group Website Technology CORE System 19100 can be interpreted by the server computers hardware 12000 and can operate to provide the desired functionality for the Personal Media Group 19200. The software platform can be divided into the following software categories: the Operating Systems (13000 to 17000) and the Client-Server topology platform including the Relational Database Management System 18000. 3) A User Web Browser Device 11100: Where the user can connect to the internet via a browser and access the Internet-Based Group Website Technology CORE System 19100 hosted in the server computers 12000. 4) A User e-mail device: Where the user can receive e-mails from the Internet-Based Group Website Technology CORE System 19100 hosted in the server computers 12000. 5) A User text-message device: Where the user can receive text messages from the Internet-Based Group Website Technology CORE System 19100 hosted in the server computers 12000.

The Internet-Based Group Website Technology System 10000 allows for the Creation of all Websites (CMSs) 19211, 19212 and 19213 (also on FIGS. 19, 20, 21, 22, 23 and 24) and the Management and Exchange of content. The system is what glues these websites (CMSs) together when creating the Personal Media Group (GCMS) 19200 also described in FIG. 5. The Internet-Based Group Website Technology CORE System 19100 can be divided in the following main components: 1) The Personal Media Group Generation System and Method 19120 referenced also on FIG. 3 and FLOW CHART 1; and 2) The Personal Media Group Communication System and Method 19110 referenced also on FIG. 4 and FLOW CHART 2.

The Personal Media Group Generation System and Method 19120: This system and methods allows for the creation of record accounts for Broadcasters [producers/distributors] (FLOW CHART 1a) on their Community Website 19212 (also (a) on FIGS. 3 and 4) created from a template 19121, it also creates record accounts for Consumers (FLOW CHART 1c) in their Community Website 19211 (also (b) on FIGS. 3 and 4) created from a template 19121 and lastly creates the Personal Media Portals 19213 (also (c) on FIGS. 3 and 4) based on a preconfigured Personal Media Portal templates 19122 that could be customized before the creation of the final websites ((c) on FIGS. 3 and 4). The Personal Media Group Generation System and Method 19120 also allows for the connection and disconnection (19230 and 19240) of a Personal Media Portal (CMS) 19123 ((c) on FIGS. 3 and 4) from or to a Personal Media Group (GCMS) 19200 (also referred on FIG. 5).

The Personal Media Group (GCMS) Communication System and Method 19110 (also FIG. 4) comprises a Media Content Update System and Method 19225 (also (2.a) on FIG. 4), a Notification System and Method 19226 (also (2.b) on FIG. 4) and an Advertisement System and Method 19227 (also (2.c) on FIG. 4).

The Media Content Update System and Methods ((2.a) on FIG. 4), can generate Media content at the community websites (CMS) level ((a) on FIG. 4) to be captured by the consumer's Personal Media Portal (CMS) ((c) on FIG. 4). This particular method of communication, from Community Website (CMS) to Personal Media Portal (CMS), is also described on FLOW CHART 2a.

The Notification System and Method ((2.b) on FIG. 4) generated at the Community (CMS) level ((a) and (b) on FIG. 4) and received at the consumers and Personal Media Portal (CMS), consumers e-mail device and consumers text-messaging device ((c) on FIG. 4). This particular method of notification is also described on FLOW CHART 2b.

The Advertisement System and Method 19227 ((2.c on FIG. 4 and FLOW CHART 2c) provides the capabilities for a Personal Media Group (GCMS), to display sponsors logos (including link to URL address) and to push keyword content, from the Consumers Community Website (CMS) 19211 to the Personal Media Portals (CMS) 19213.

The Communication Channel Manager 19220 supports all methods of communication: the Media Content Update System, the Notification System and the Advertisement System; by comprising a Media Content Update Manager 19225, a Notification Manager 19226, a multi-directional manager 19223, a channel set up 19221 (also described on FIG. 8), a Posting Manager 19224 and a Broadcast Manager 19222. The communication method allows for communication-direction among the entity websites 2000 as described on FIG. 7 providing the following directions of communication: 1) Communication-Direction within the Personal Media Group 2100: 1.a) From Broadcaster Community Website to Consumer Community Website 2110 1.b) From Consumer Community Website to Personal Media Portal 2120 1.c) From Consumer Community Website to E-Mail Device 2130 1.d) From Consumer Community Website to Text Message Device 2140. 2) Communication-Direction among Personal Media Groups 2200: 2.a) From Broadcaster Community Website from Personal Media Group “B” to Broadcaster Community Website from Personal Media Group “A” 2210

The Communication Channel Set Up System and Method 19221 (also described on FIG. 8), defines and establishes a direction of communication for Media Content Updates, Advertisement Content and Notification Content sent among websites 19213 and to e-mail devices 11200 and text-messaging 11300 devices within or among Personal Media Groups 19200 across the internet. FIG. 8, shows content from the Media Content Update system, being sent from a Broadcaster (Producer/Distributor) (community 19212) to a Consumer (Personal Media Portal 19213, Consumer E-Mail Device 11200 and Consumer TEXT-Messaging Device 11300). The Broadcaster will include a communication channel module 3000 in a page of the community 19212. Then, on the channel id holder 3100 of the channel module 3000 will include a new channel id 3110 specified by a naming convention for the channels. Then, on the body section of the module 3200 will include the video/audio “DEF” to be sent 3210. The Broadcaster then will list in the community website the program of each channel. The Consumer, then will include a communication channel module 3000 in a page of his website or Personal Media Portal 19213. Then, on the channel id holder 3100 of the channel module 3000 will include the channel id 3110 specified by the Broadcaster. The Consumer has the control of redirecting the messages included in the content broadcast to his e-mail device by specifying +E and to his text-messaging device by specifying +T on the channel id 3110. Later, the Broadcast Manager 19222 will push the video/audio “DEF” from the Broadcast Community to the Personal Media Portal, e-mail and text-messaging devices, following the Broadcast Direction for the Channel (2140, 2141 and 2142 respectively). The e-mail device 11200 will receive an e-mail from the Personal Media Group with a Reference Id 3310 specifying the channel id and in the body of the e-mail 3320 the message related to the content “DEF” transmitted 3210. The text-messaging device 11300 will receive a text message with a Reference Id 3410 specifying the channel id and in the body of the text message 3420 the message related to the content “DEF” 3210.

The Posting Manager 19224 is an intermediate stage between the process of saving a notification and broadcasting 19222 the notification to the receivers. If a particular notification massage is save, but not posted, then the broadcast manager 19222 will not broadcast the message. The broadcast manager 19222 will only broadcast posted notifications.

The Broadcast Manager 19222 will broadcast all content from Media Content Update System and from the Advertisement and Notification System based on a Scheduler 19252.

The Personal Media Group Generation 19120 process (FIG. 9—FLOW CHART 1), is the process followed to create the Personal Media Group 19200. In this process, Broadcasters (Producers and Distributors) and Consumers of Media Content (Text/Video/Audio files, program schedules and channels) will be registered in the system as accounts in the Broadcasters (a) 19212 and Consumers (b) 19211 Community Websites (CMSs). The Consumers will also receive a Personal Media Portal (c) (CMS) with a preconfigured design 19213.

The process is composed by 4 sub-processes: 1) The Broadcaster's Account Generation Process 19128 (FIG. 10—FLOW CHART 1a); 2) The Broadcaster's Program/Channel Schedule Creation 19128 (FIG. 11—FLOW CHART 1b); 3) The Consumer's Account Generation Process 19128 (FIG. 12—FLOW CHART 1c); 4) The Consumer's Personal Media Portal Creation 19129 (FIG. 13—FLOW CHART 1d)

The Broadcaster's Account Generation Process (FIG. 10—FLOW CHART 1a, 4000) is the process followed to generate a Broadcaster's record on the Broadcaster's Community Website 19212. This process can be executed manually 4110, by entering the information of one Broadcaster at a time; or can run on a batch mode 4120, by reading the information from an input file 4121 containing records with the information from all the Broadcasters to be uploaded in the Community Website 19212. Once the data is captured 4100, the process will validate 4200 the information for accuracy providing as an output a Data Validation Error Report 4211. If the validation succeeds, the process will continue to save 4300 the information in the Broadcaster's Community Website 19212.

The Broadcaster's Program/Channel Schedule Creation (FIG. 11—FLOW CHART 1b, 6000) is the process followed to create a records in the Broadcasters Community 19213 (website) related to Program/Channel Schedules. This process can be executed manually 6110, by creating the Program/Channel Schedules for one Broadcaster at a time; or can run on a batch mode 6120, by reading the information from an input file 6121 containing records with the information from all Program/Channel Schedules. The process will validate 6210 the information first, generating a Data Validation Error Report 6211. If the validation process succeeds, then the process will build 6300 the Broadcasters Program/Channel Schedules in the Broadcasters Community Website Database.

The Consumer's Account Generation Process (FIG. 12—FLOW CHART 1c, 5000) is the process followed to generate a consumer's record on the Consumer Community Website 19211. This process can be executed manually 5110, by entering the information of one Consumer at a time; or can run on a batch mode 5120, by reading the information from an input file 5121 containing records with the information from all the Consumers to be uploaded in the Community Website 19211. Once the data is captured, the process will validate 5200 the information for accuracy providing as an output a Data Validation Error Report 5211. If the validation succeeds, the process will continue to save 5300 the information in the Consumer's Community Website 19211.

The Consumer's Personal Media Portal Creation (FIG. 13—FLOW CHART 1d, 7000) is the process followed to create a Consumer's Personal Media Portal 19213 (website). This process can be executed manually 7110, by creating the Personal Media Portal 19129 for one Consumer at a time; or can run on a batch mode 7120, by reading the information from an input file 7121 containing records with the information from all the Consumers that will need a Personal Media Portal 19213. The process will validate 7210 the information first, generating a Data Validation Error Report 7211. If the validation process succeeds, then the process will build 7300 the Consumers Personal Media Portal based on a preconfigured Portal Template 19122 for the consumer. The domain name with the consumer's name with extension .tv will be created 19254 to access the consumer's Personal Media Portal.

The Personal Media Group Communication process (FIG. 4) (FIG. 14—FLOW CHART 2) is the process followed to establish a communication between the Broadcaster and the Consumer entity. This communication is a technology communication involving the Community Websites 19211 19212 ((a) and (b) on FIG. 4), the Personal Media Portals 19213 and the entity's e-mail 11200 and text messaging 11300 devices ((c) on FIG. 4).

The Personal Media Group Communication (FIG. 4) (FIG. 14—FLOW CHART 2) is the way the Broadcasters and Consumers will interact within the Personal Media Group 19200

The Broadcasters Community ((a) on FIG. 4), is where all Broadcasters have an account and where they can participate in Forums, receive support, training, etc. . . . as well as post their Program/Channel Schedules in the Media Content Update System ((2.a) on FIG. 4) for consumers, create and send Notifications ((2.b) on FIG. 4) to consumers and advertise using the Advertisement System ((2.c) on FIG. 4) to consumers.

The Consumers Community ((b) on FIG. 4), is where all Consumers have an account and where they can participate in Forums, receive support, training, etc. . . . as well as purchase a subscription to a Personal Media Portal.

The Personal Media Portals for Consumers ((c) on FIG. 4) is where they go to watch, listen, interact and use the media content provided by broadcasters (Television, Radio, News, Songs[Music], Movies, PC[Cloud Computer], Home[Virtual Home], Phone[Video Conferencing], etc.) over the internet.

These websites (CMSs), have also the ability to create links and feeds to and/or from the TV Networks entity website (i.e.: MSNBC Website) by supporting the standards for Links and RSS Technology (Really Simple Syndication).

The communication process (FIG. 14—FLOW CHART 2) is composed by 3 sub-processes: 1) Media Content Update process (FIG. 15—FLOW CHART 2a); 2) Notification Process (FIG. 16—FLOW CHART 2b); 3) Advertisement Process (FIG. 17—FLOW CHART 2c)

The Media Content Update Process (FIG. 15—FLOW CHART 2a) is where a Broadcaster or Consumer can post a media content related to Text/Video/Audio script on the system at the Broadcaster's Community Websites 19211, and then, Consumers can retrieve at their Personal Media Portals 19213 the media content that will publish the media Text/Video/Audio provided by the Broadcaster.

The first step executed in this process, is the Preparation of the media content 8110 comprising the step of including a new Communication Module 8111 and then including the Channel Id and the media content 8112, the media content will be saved (or posted) to the Broadcaster's Community Website 19212. The Consumer, can include under his/her profile on the Consumer's Community Website 19211, what programs/channels are desired to be published (8121 and 8122 on FIG. 15—Flowchart 2a) to his/her own Personal Media Portal 19213.

The Media Content Broadcast process 8130, runs on a scheduler 19252, and when is time to propagate 8131, the process will read the media content posted by the Broadcaster and Selected by the Consumer in each respective Community (19211, 19212) and will broadcast 8132 to the Consumer's Personal Media Portals 19213, expecting the Media Content based on the Program/Channel Schedule.

By using the Video/Audio system, each Consumer or Broadcaster has the flexibility and convenience of just including the Program/Channel Schedule related only of the Media Content of interest.

The Notification Process (FIG. 16—FLOW CHART 2b), is the process followed to notify Consumers and/or Broadcasters of a particular event.

The first step executed in this process, is the Preparation of the Notification 8210, the creator of a Notification (a Broadcaster) will prepare a Notification by imputing 8211, validating 8212 and saving 8213 such notification in the Broadcaster's Community Website 19212. The configuration of the Notification allows defining the type of notification (Emergency 8221 or Standard 8222), a selection criteria based on attributes of the recipients (subgroup of Consumers) and the Notification method (website 11100, e-mail 11200 and text-message 11300, also (c) on FIG. 4).

The Type of Notification includes the Emergency Notification 8221 and Standard Notification 8222. While the Emergency Notification is sent to everyone in the Personal Media Group and sent via all notification methods; the Standard Notification is configurable, so it can be sent to a specific subgroup of Consumers and only via a specific notification method.

The Selection Group to send the notification too, is user defined and represents the different groups of interest within the Personal Media Group (i.e.: region, state, county, city, or topic, channel, etc). The selection Group is configured based on the Personal Media Group where this is implemented, creating an easy way to group Consumers based on a common interest or topic.

The Notification Method includes the notification sent to the Personal Media Portal 19213 (website) to a web browser device 11100, sent via E-mail device 11200 and sent via Text Message device 11300 (Cell phone, PDA, Mobile Devices, etc. . . . )

Once the Notification is prepared and saved 8213 in the Broadcaster's Community Website 19212, then the creator of the Notification or a different user (user defined internal controls) can execute the Posting Process 8220.

The Posting Process 8220 will review the notification configuration. If the notification is an Emergency Notification 8221, then will post the notification in all Personal Media Portals 19213 (Consumers), will send the notification via e-mail 11200 and text message 11300 to Consumers and Consumer's additional e-mails and text message accounts.

If the notification is a Standard Notification 8222, then the process will execute the posting based on the notification configuration that will determine the selection group of recipients for the notification and the notification method to be used.

The Advertisement Process (FIG. 17—FLOW CHART 2c, 8300), is the process followed by Broadcasters to send advertisement to Consumers. This process uses the communication channel manager 19220.

The first step is the preparation of the add 8310, where the Advertisement Logo File, Keyword & URL Link is entered into the Consumers Community 19211 website. The second step 8320 is to enter the Add location URL Address also in the Consumers Community 19211. The third step is to broadcast the Add Location URL Address 8330 to all Personal Media Portals 19213.

The Portal Display Type Selection process (FIG. 18—FLOW CHART 3, 9000), is the process followed by the Media Consumer when interacting with his/her Personal Media Portal. Depending on which Web Browser Devise is intending to use, the Media Consumer will select a subsection of the portal specifically configured for the device selected. The Media Consumer can select to use his/her Personal media Portal from his/her Plasma Size Web Browser Device 9100, Computer Size Web Browser Device 9200, Car Display Web Browser Device 9300 or Mobile Phone Display Size Web Browser Device 9400. The devise selected will take the Media Consumer user directly to the respective system and methods.

System Architecture:

The system architecture of a prefer embodiment of a Personal Media Group Website Technology System 10000 according to the present invention is presented in FIG. 1. Referring now to FIG. 1, Personal Media Group Website Technology System 10000 comprises an Internet-Based system architecture that can be divided into two groups, the User Access Devices 11000 and the Hosting Server Computers 12000.

The User Access Devices 11000 further comprises a web browser device 11100, an e-mail device 11200 and a text-messaging device 11300.

The Hosting Server Computers 12000 further comprises an operating system 13000, a web server hosting 14000, an application framework system 15000, a visual studio .net system 16000, an office applications system 17000, a client—server system platform (file system—RDBMS Database Engine) 18000, and the www.GoToYourSite.com website technology development and hosting platform 19000.

The www.GoToYourSite.com website technology development and hosting platform 19000, further comprises the internet-based group website technology core system 19100.

The internet-based group technology core system 19100, further comprises the Personal Media Group communication system 19100 and the Personal Media Group generation system 19120.

The Personal Media Group generation system 19120, generates the Personal Media Group 19200. The Personal Media Group generation system 19120, further comprises a community website template 19121, a Personal Media Portal template 19122, a template inventory 19123, a template factory 19124, a module inventory 19125, a module factory 19126, a Media Broadcaster and Media Consumer community generator 19127, a Media Broadcaster (including a Program/Channel Schedule) and Media Consumer account generator 19128 and a Consumer Personal Media Portal generator 19129.

The Personal Media Group 19200, further comprises a Media Consumer community website development environment (CMS) 19211, a Media Broadcaster community website development environment (CMS) (including a Program/Channel Schedule) 19212, a group of Personal Media Portals (CMSs—websites development environments) for Media Consumers 19213, an inappropriate content search engine manager 19214, a communication channel manager 19220, a Personal Media Portal transfer manager 19230, an Personal Media Group manager 19240, a mail manager for e-mail and text-message 19251, a task scheduler 19252, a custom integration to other applications module 19253, a domain name registration 19254, a security system 19255, an encryption certificate activation 19256 and a payment processing 19257.

The Personal Media Portal transfer manager 19230, further comprises the import manager 19231 and the export manager 19232.

The Personal Media Group manager 19241, further comprises the road map manager 19241 and the graduation manager 19242 (also described on FIG. 6).

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawing and FIGURES, wherein:

FIG. 1 is a software architectural block diagram of a preferred embodiment of a personal media group system according to the present invention;

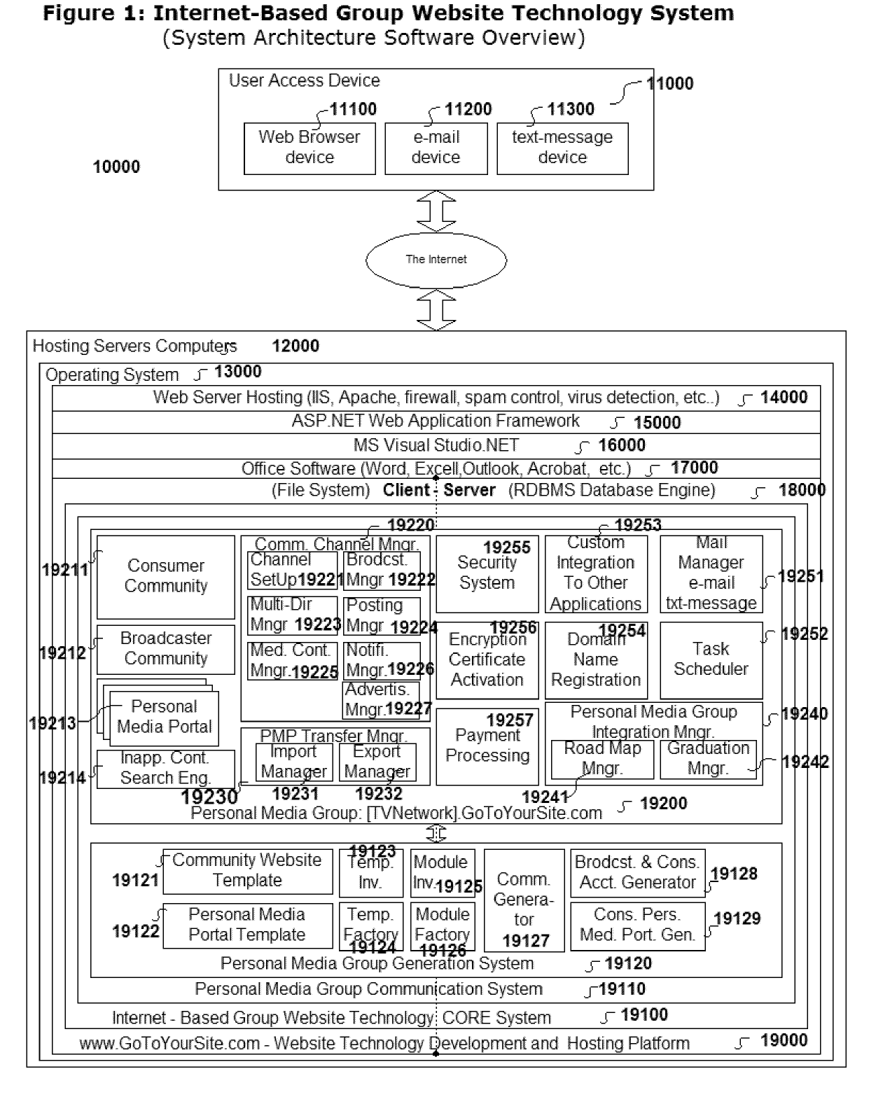

FIG. 2 is a hardware architectural diagram of a preferred embodiment of a personal media group system according to the present invention;

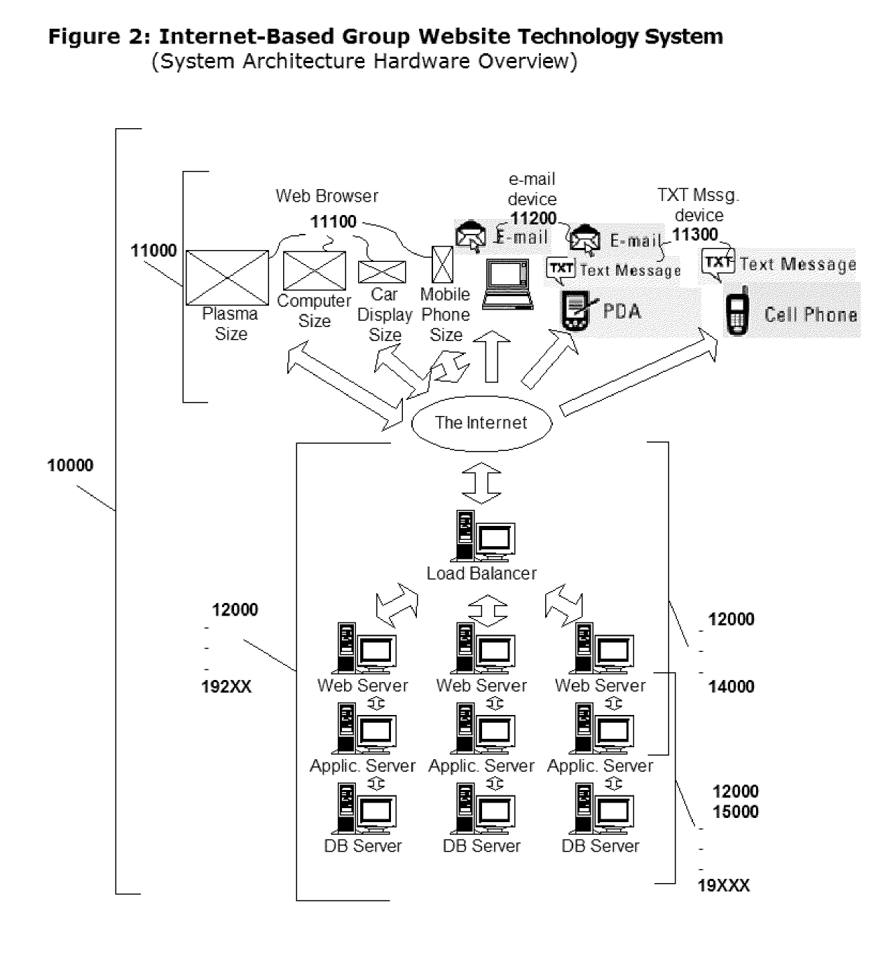

FIG. 3 is a CMS entity and process diagram representing the generation of the personal media group according to the present invention;

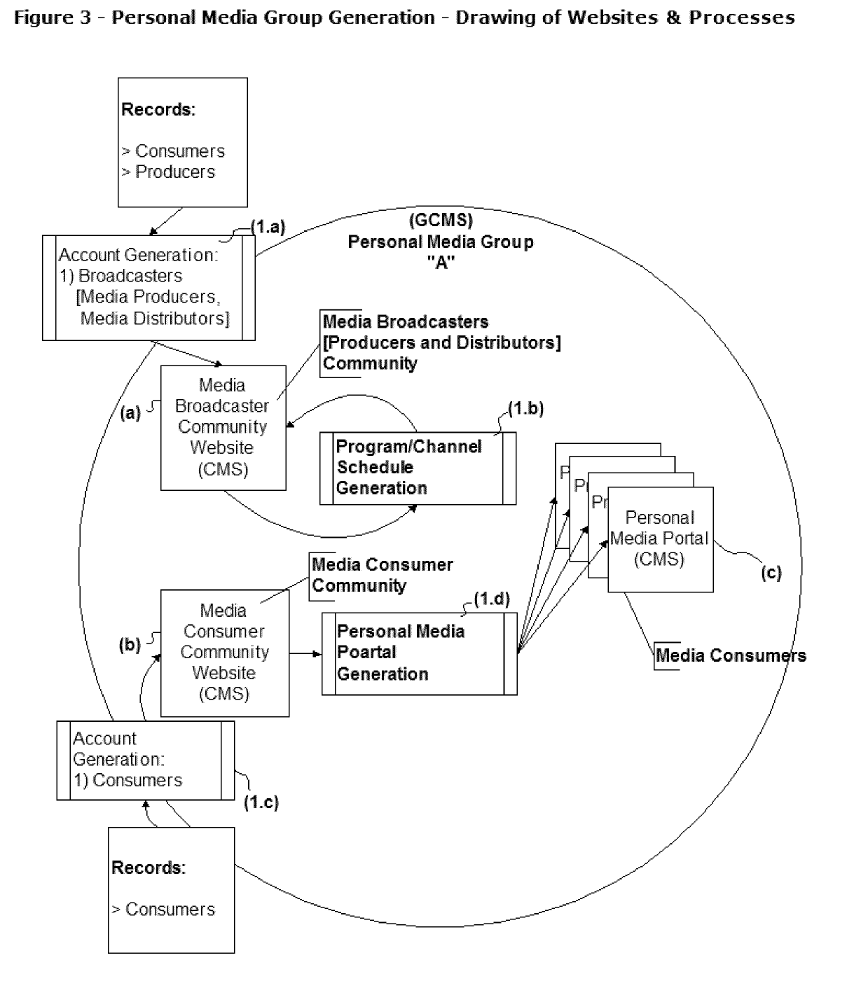

FIG. 4 is a CMS and Device entity, process and feature description diagram representing the personal media group communication capabilities according to the present invention;

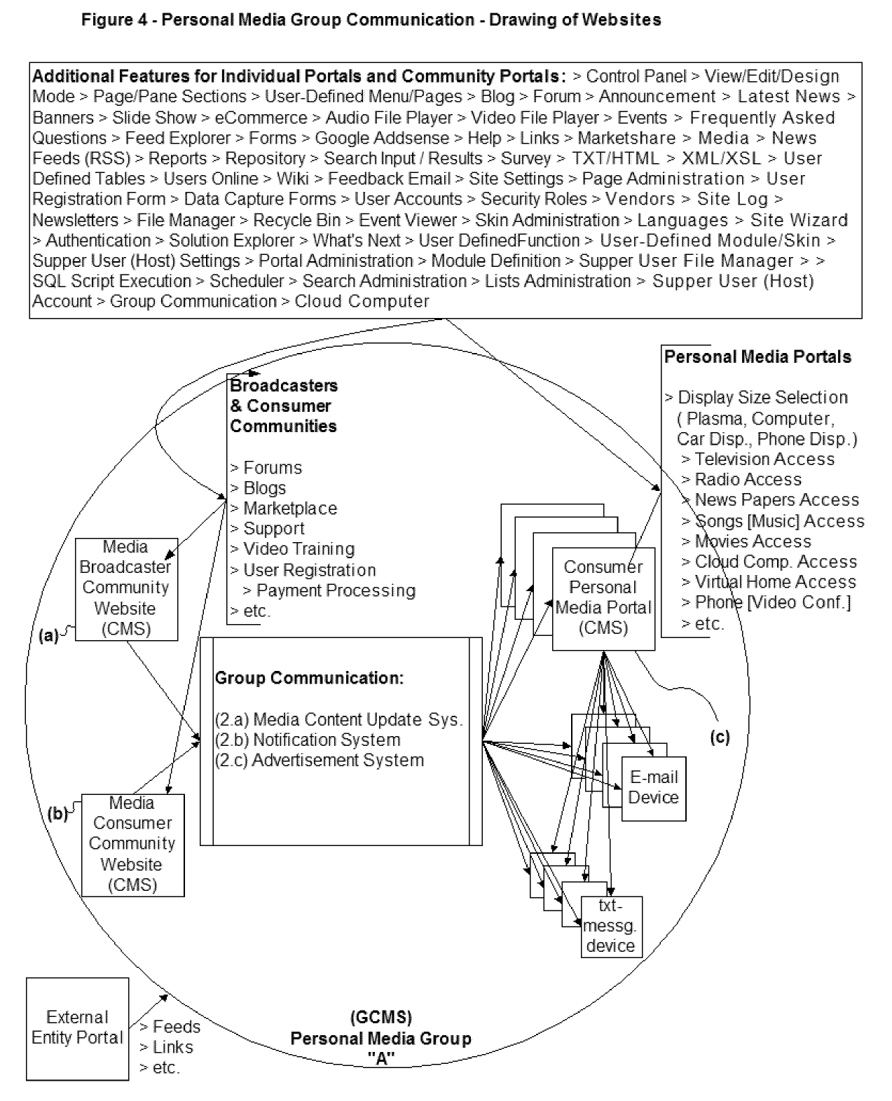

FIG. 5 is a hierarchical CMS and Device Entity relationship diagram representing the personal media group entity components according to the present invention;

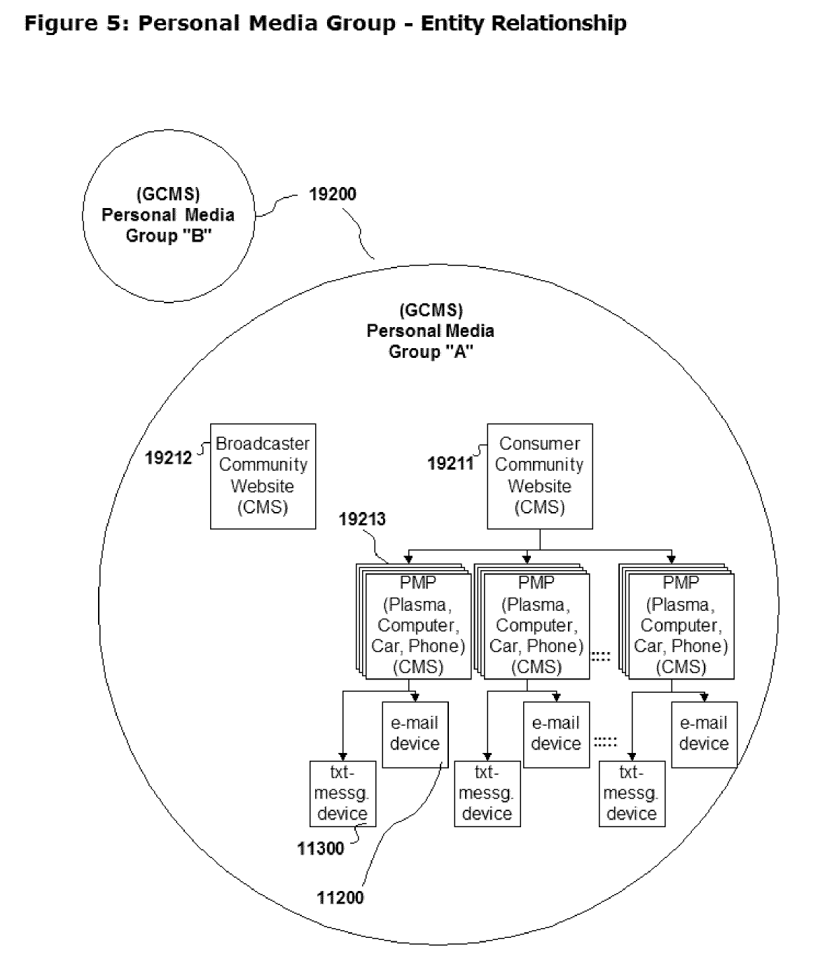

FIG. 6 is a CMS entity diagram describing the personal media group (GCMS) interacting with other groups (educational group [GCMS], commercial group [GCMS]) and how a personal media portal (CMS) can merge with other portals (professional portal [CMS]) according to the present invention;

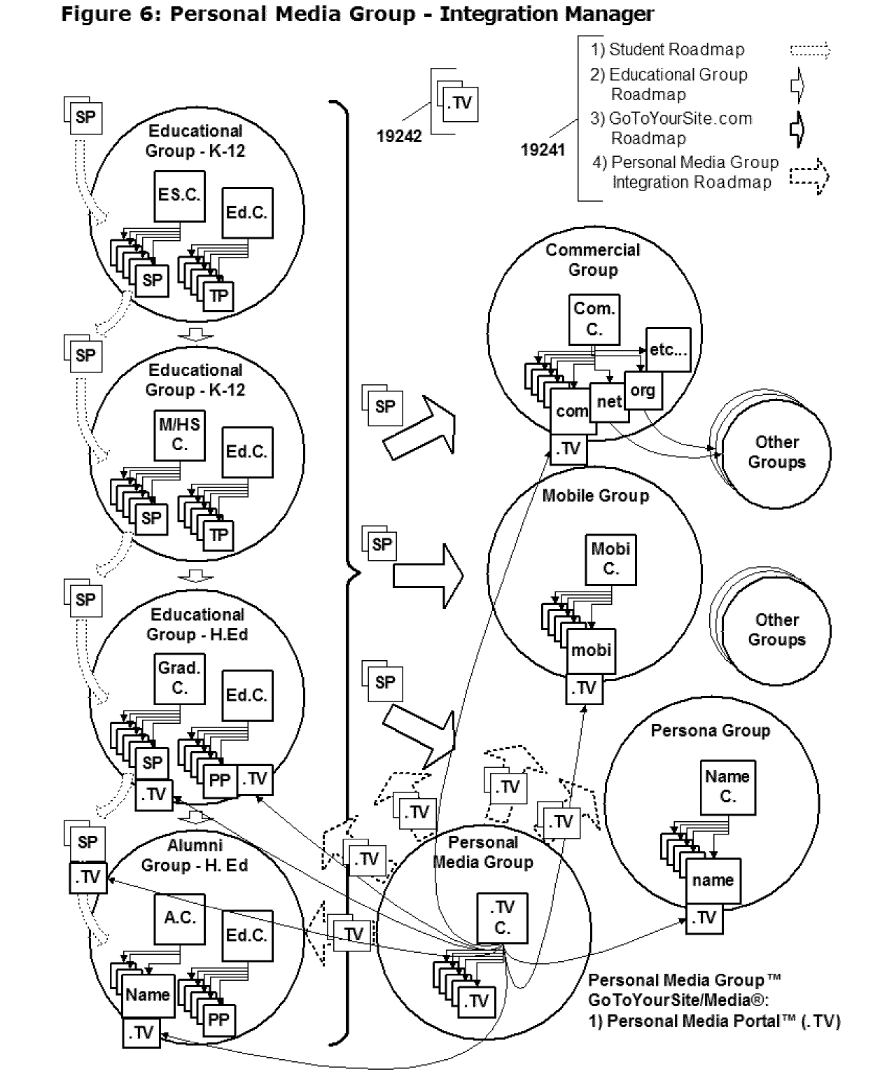

FIG. 7 is a CMS entity diagram describing the communication direction between entity portals (community CMS and personal media portals CMSs) according to the present invention;

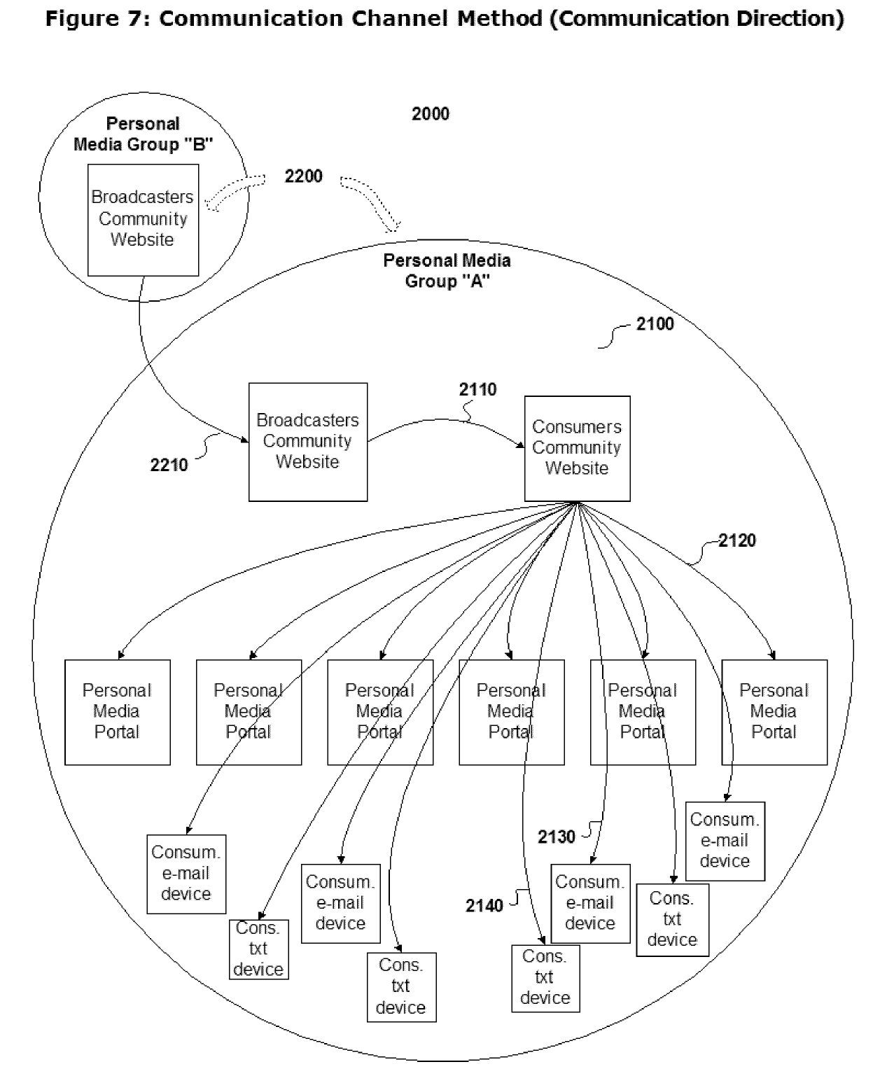

FIG. 8 is CMS (website) page entity diagram describing the communication channel set up method for the broadcaster and consumer personal media portal according to the present invention;

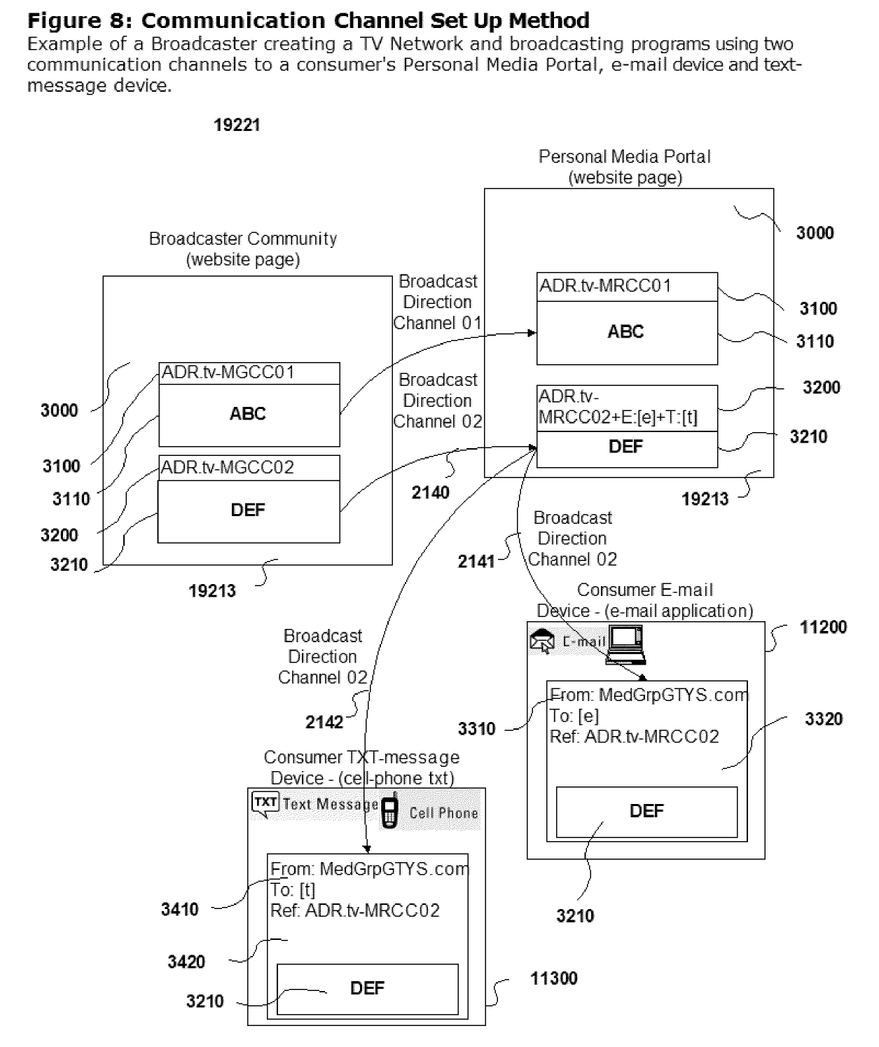

FIG. 9 is a flowchart of decisions and processes (Flow Chart 1) representing an orderly sequence of steps in the generation of the personal media group (GCMS) according to the present invention;

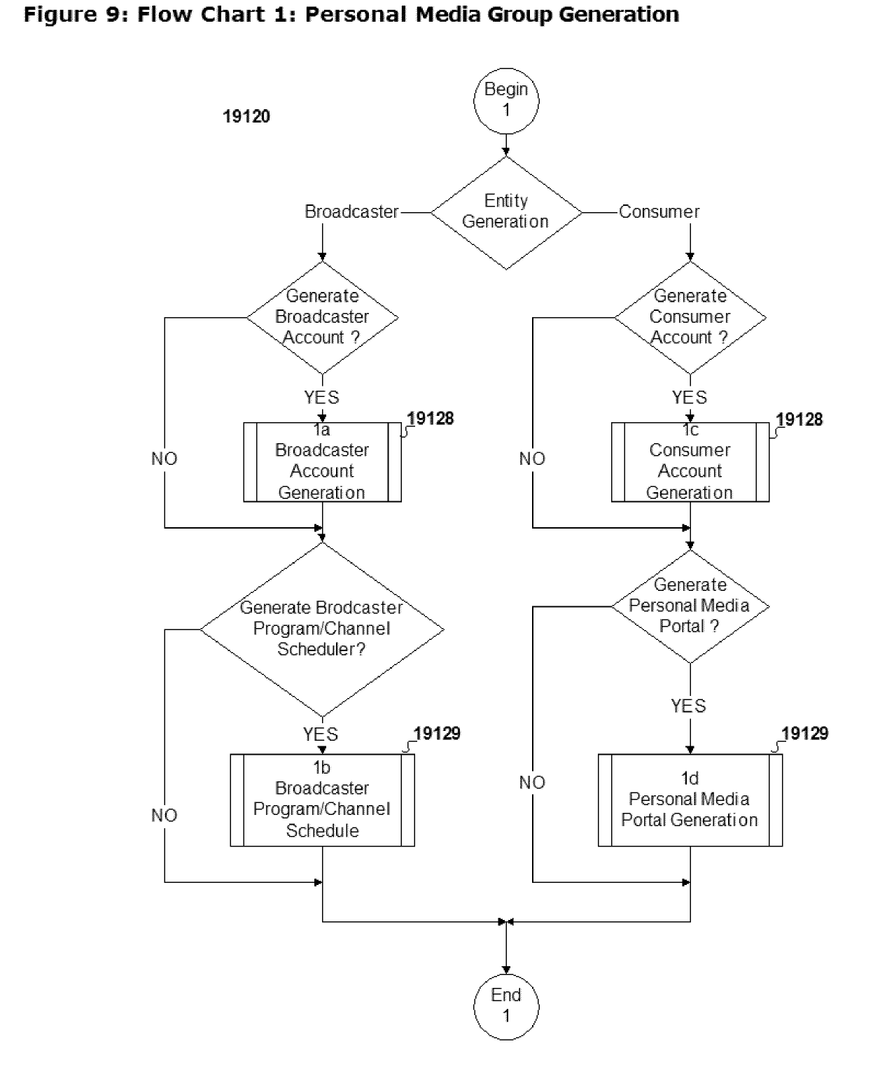

FIG. 10 is a flowchart of decisions and processes (Flow Chart 1a) representing an orderly sequence of steps in the generation of the broadcaster account in the broadcaster community (CMS) according to the present invention;

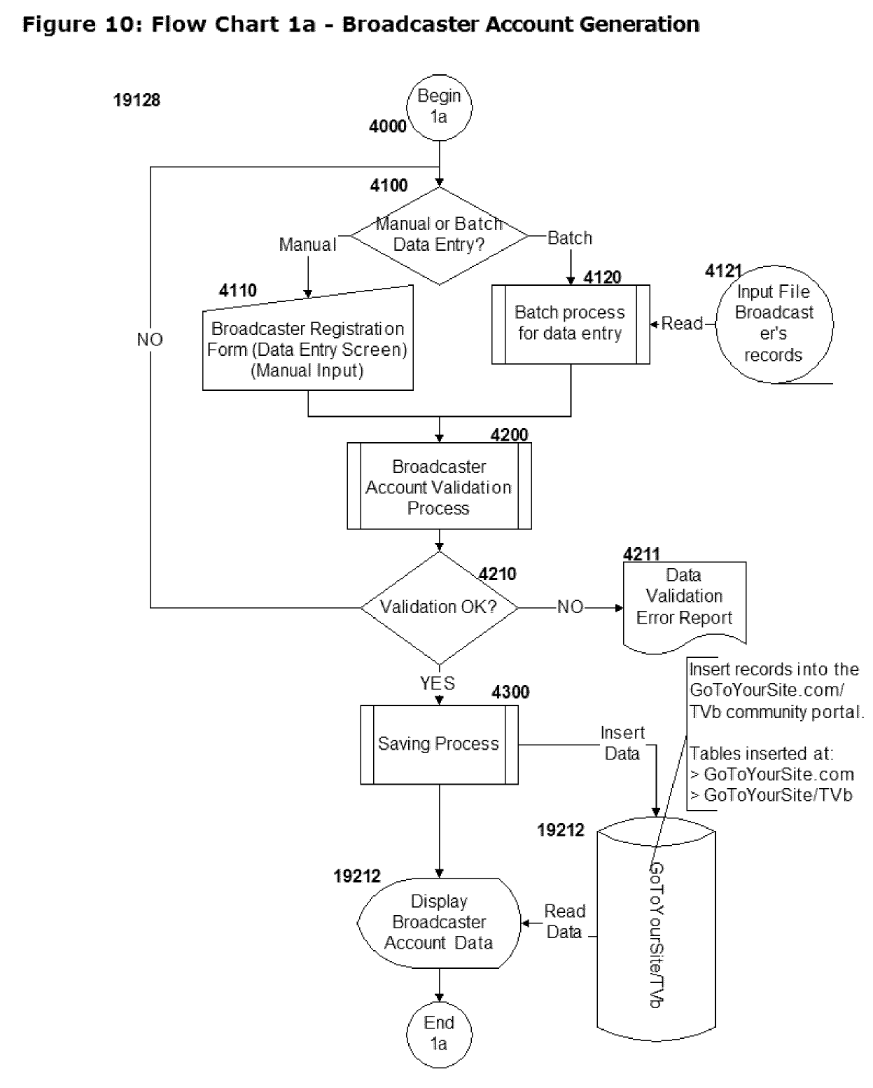

FIG. 11 is a flowchart of decisions and processes (Flow Chart 1b) representing an orderly sequence of steps in the generation of the broadcaster's Program/Channel Schedule in the broadcasters community (CMS) according to the present invention;

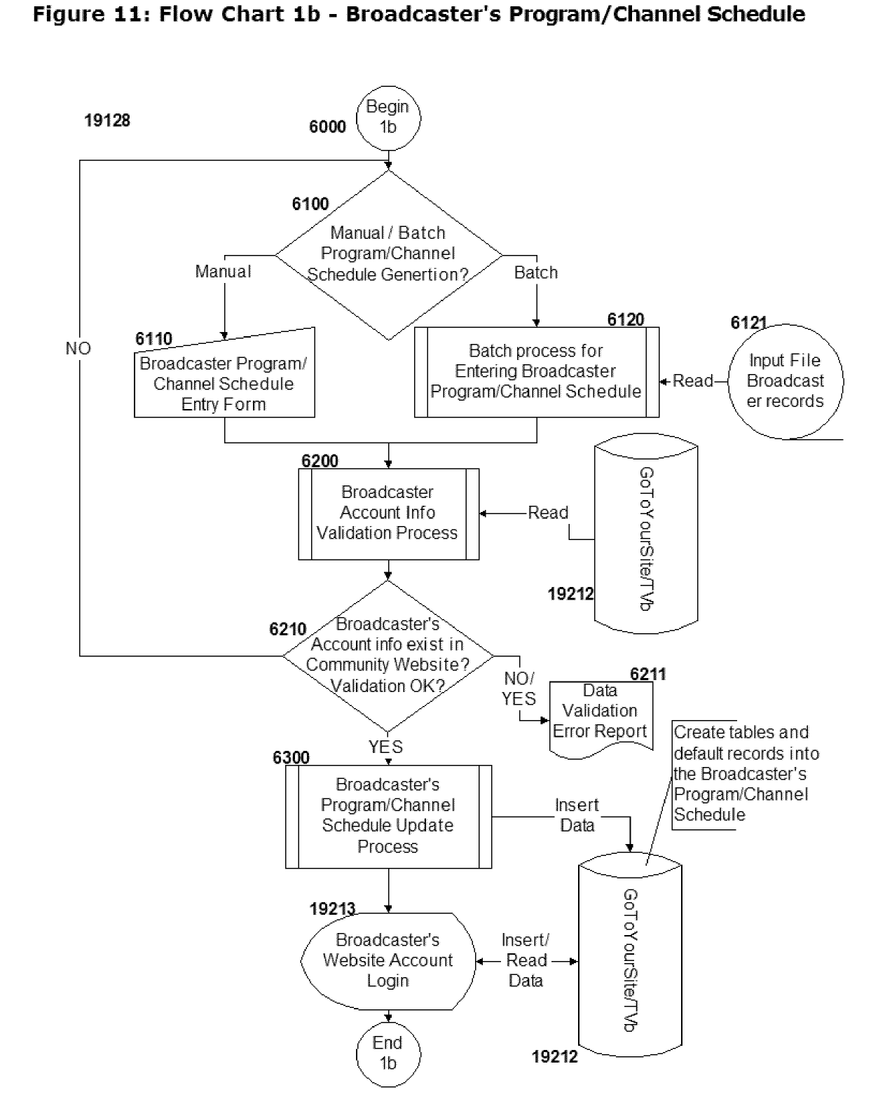

FIG. 12 is a flowchart of decisions and processes (Flow Chart 1c) representing an orderly sequence of steps in the generation of the consumer's account in the consumers community (CMS) according to the present invention;

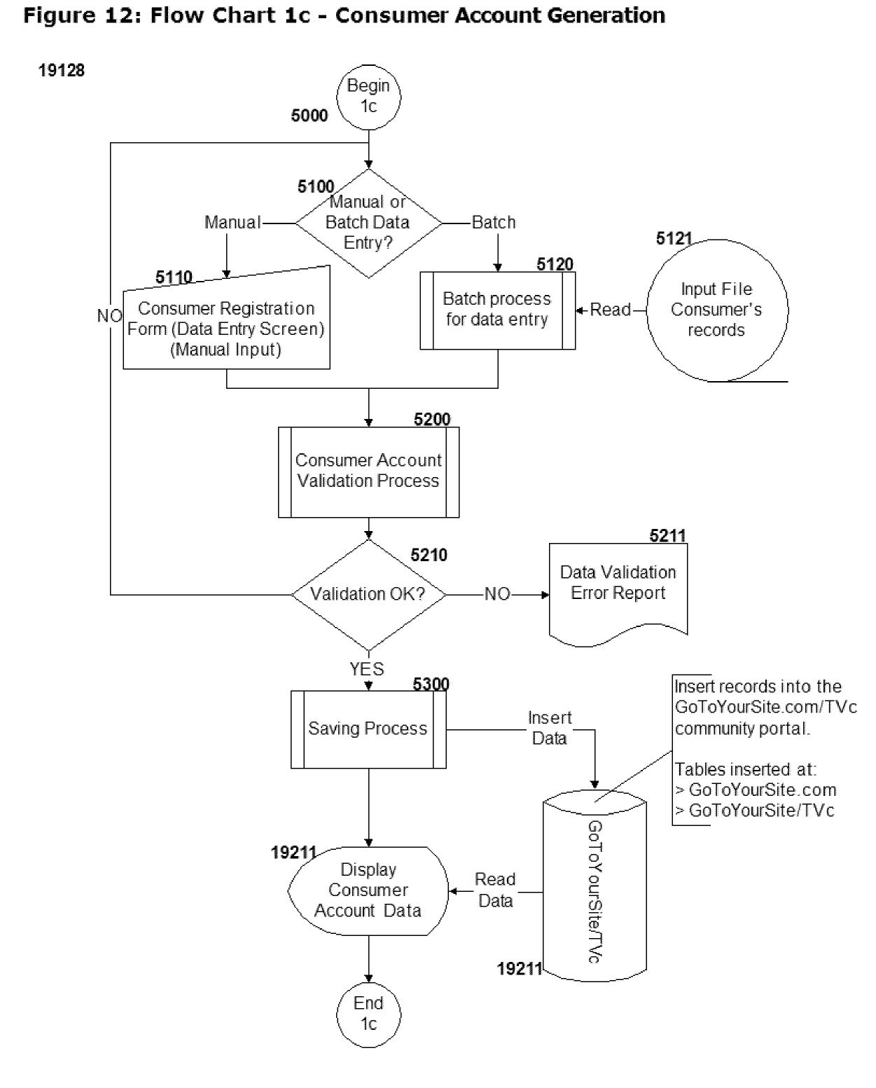

FIG. 13 is a flowchart of decisions and processes (Flow Chart 1d) representing an orderly sequence of steps in the generation of the consumer's personal media portal (CMS) according to the present invention;

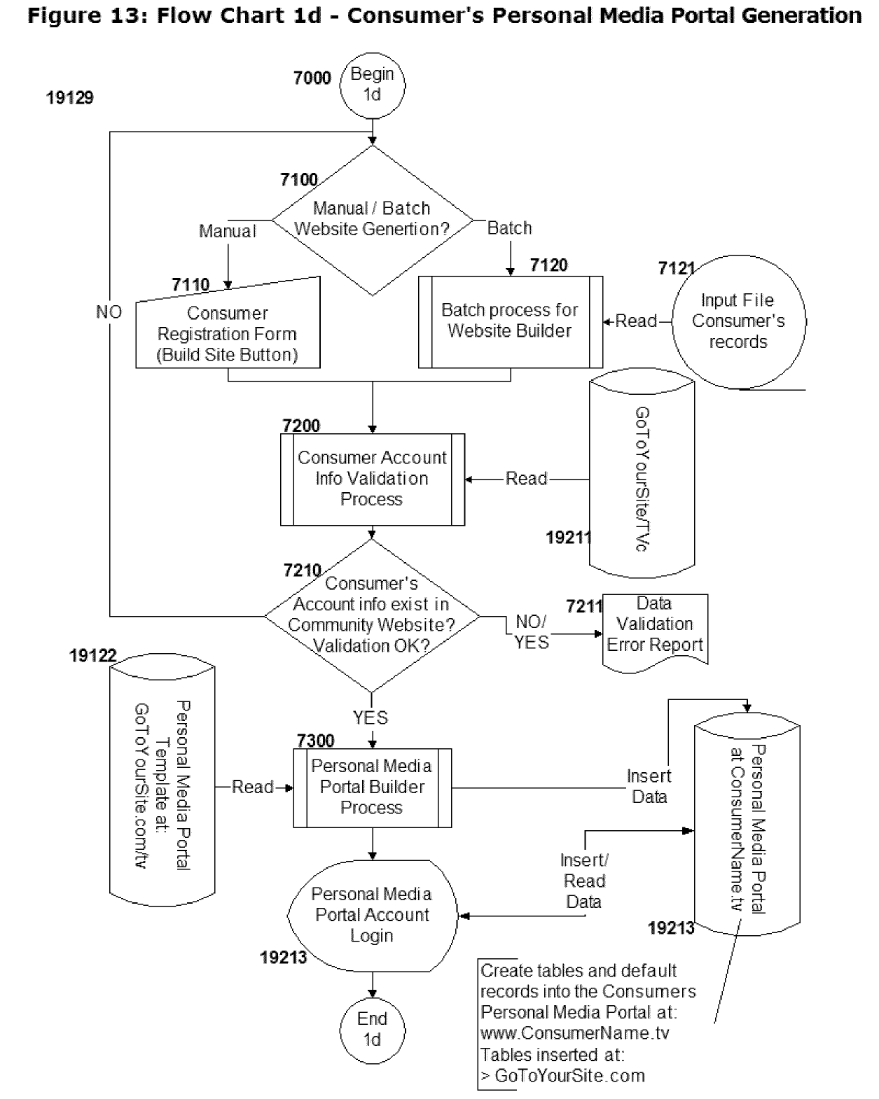

FIG. 14 is a flowchart of decisions and processes (Flow Chart 2) representing an orderly sequence of steps in the selection and execution of personal media group (GCMS) communication types according to the present invention;

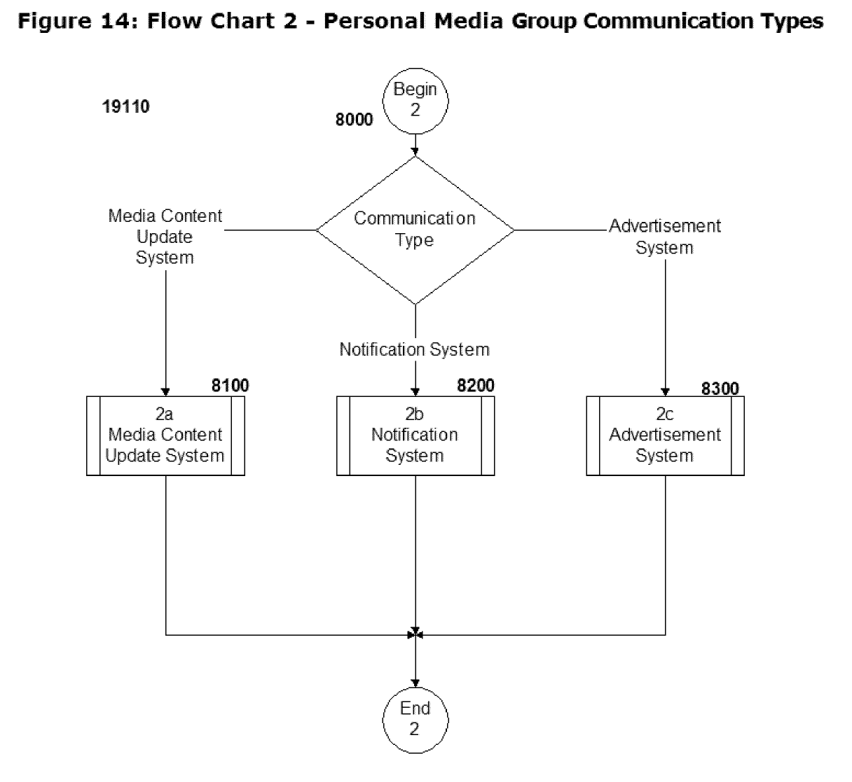

FIG. 15 is a flowchart of decisions and processes (Flow Chart 2a) representing an orderly sequence of steps in media content update communication system within the personal media group (GCMS) according to the present invention;

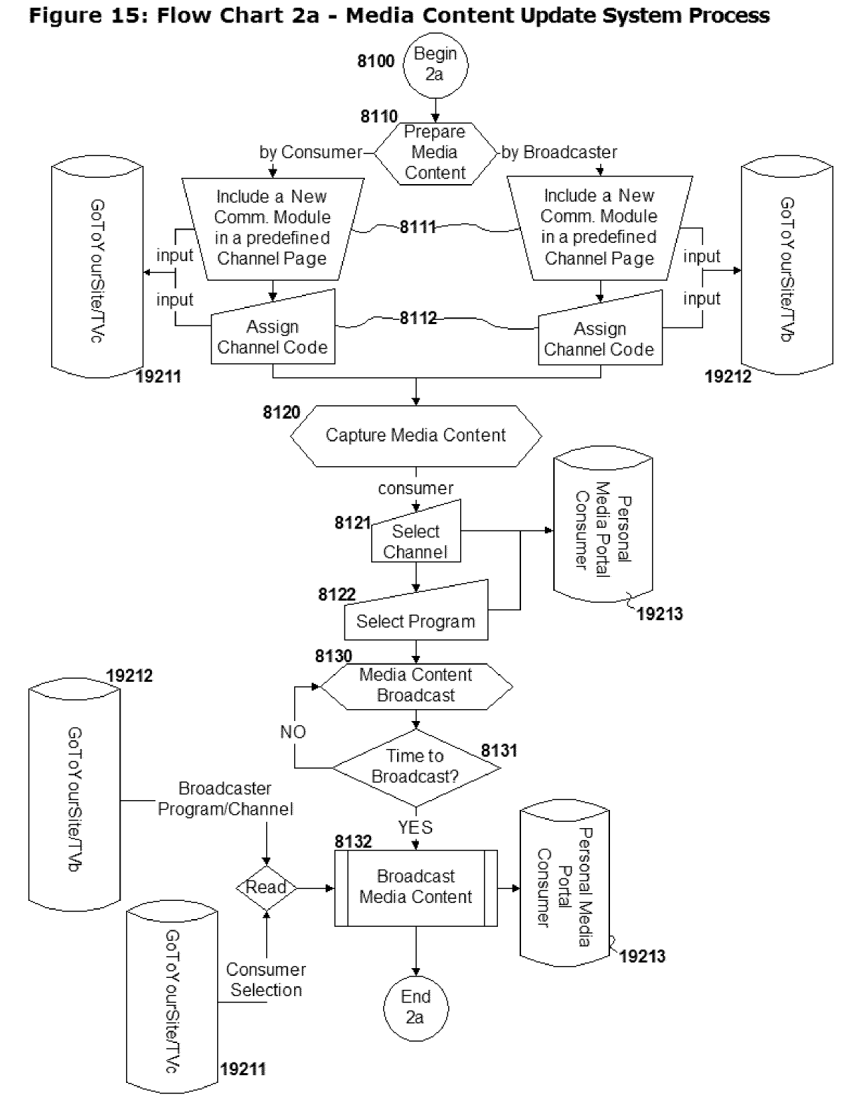

FIG. 16 is a flowchart of decisions and processes (Flow Chart 2b) representing an orderly sequence of steps in the notification communication system within the personal media group (GCMS) according to the present invention;

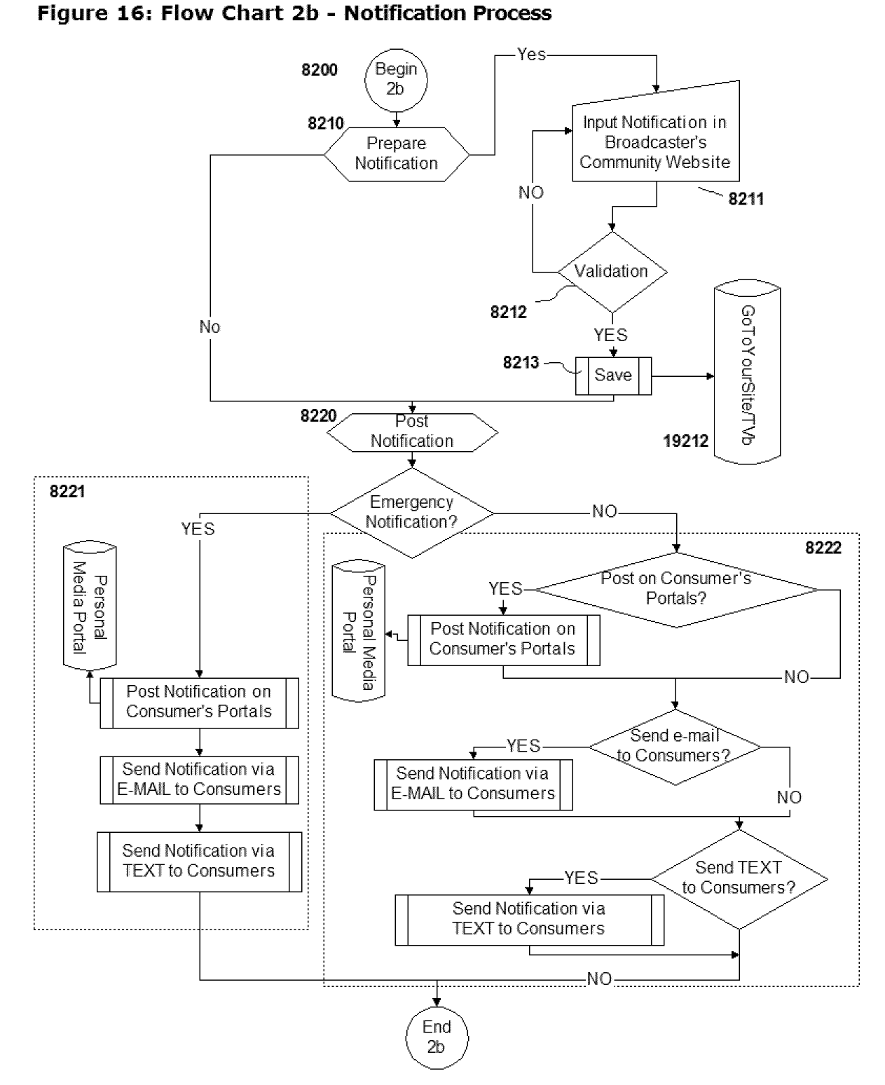

FIG. 17 is a flowchart of decisions and processes (Flow Chart 2c) representing an orderly sequence of steps in the advertisement communication system within the personal media group (GCMS) according to the present invention;

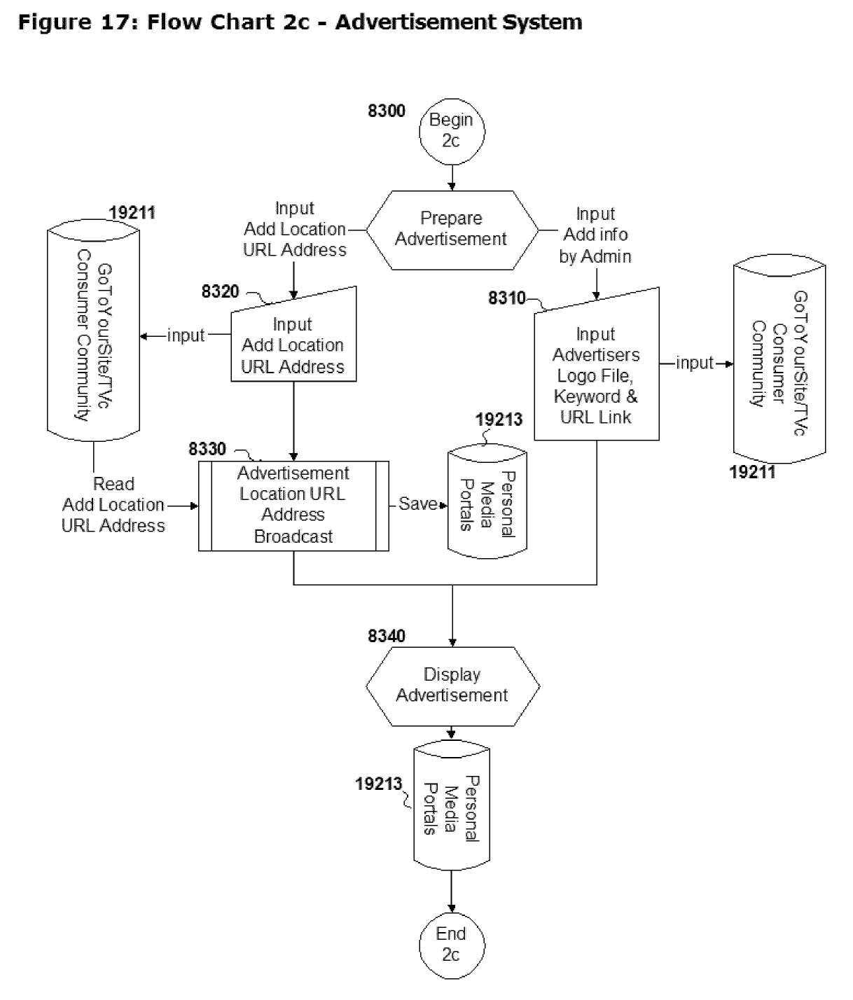

FIG. 18 is a flowchart of decisions and processes (Flow Chart 3) representing an orderly sequence of steps in the selection of access to a section of the personal media portal (CMS) to fit the selected web browser device (plasma size, computer size, car display size or mobile phone size) according to the present invention;

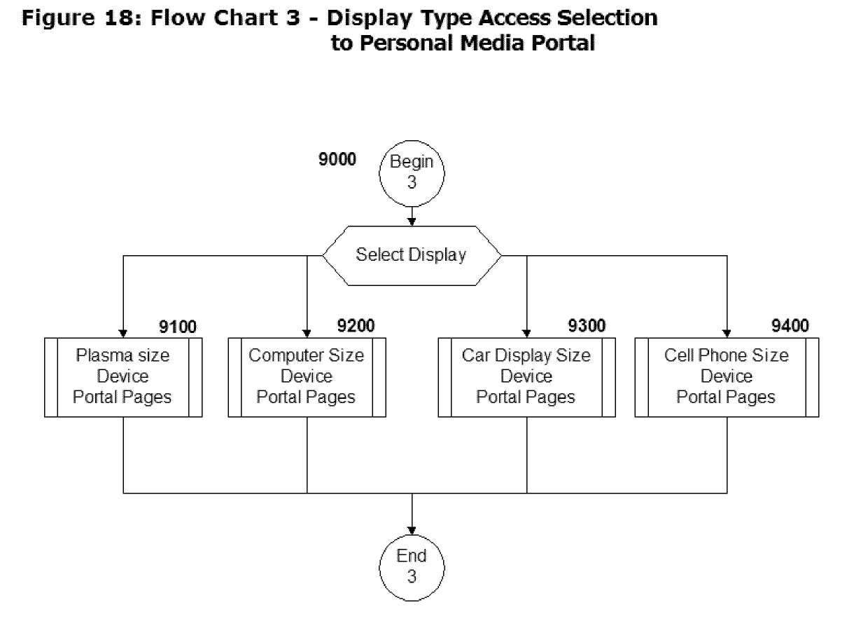

FIG. 19 is a screen shot of a personal media portal (CMS) generated from the personal media group (GCMS) generation process, showing the control panel section with available modules to be selected by the Admin Users or personal media portal user;

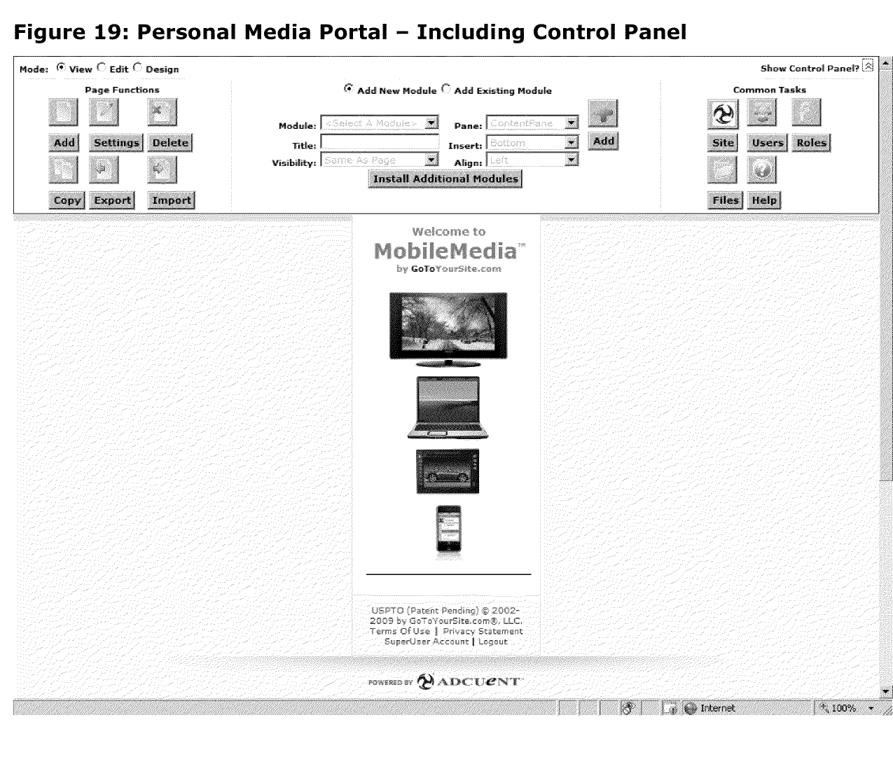

FIG. 20 is a screen shot of the personal media portal (CMS phone size) menu options page, TV Menu page, and TV Channels page and TV Channel selected content page;

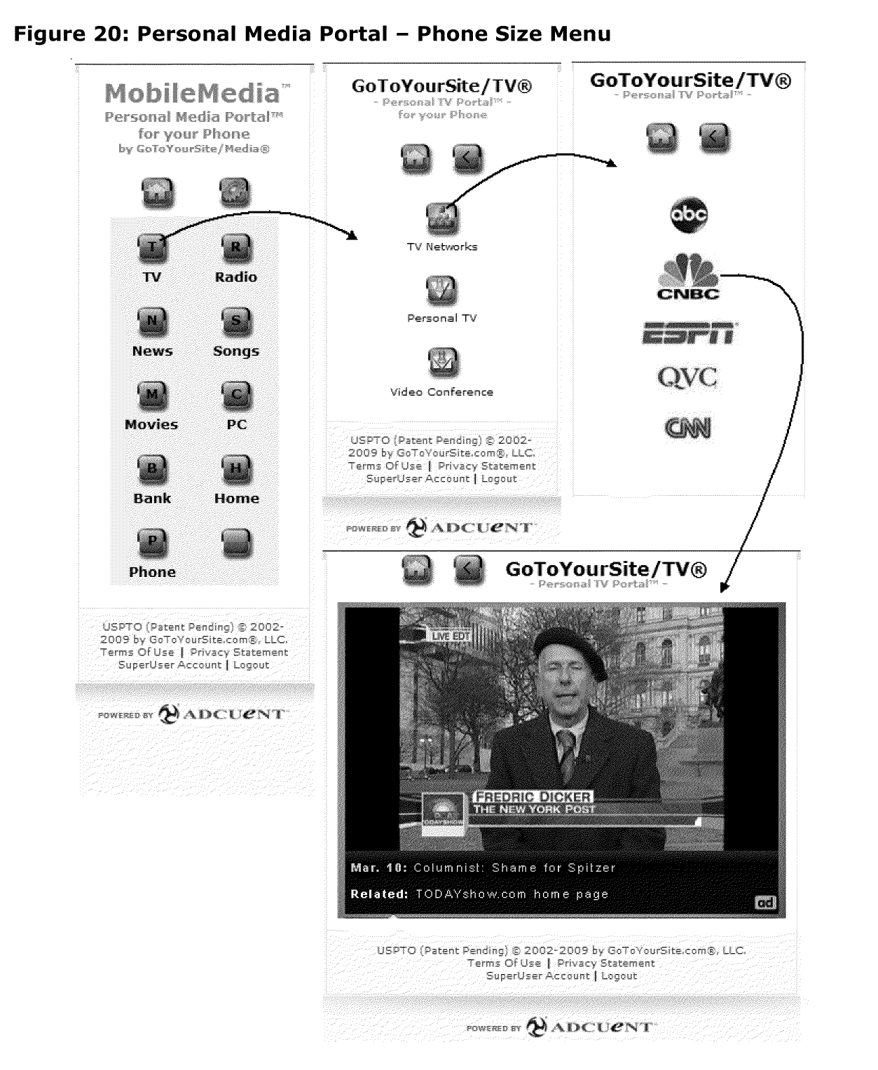

FIG. 21 is a screen shot of the personal media portal (CMS car display size) menu options page, TV Menu page, and TV Channels page and TV Channel selected content page;

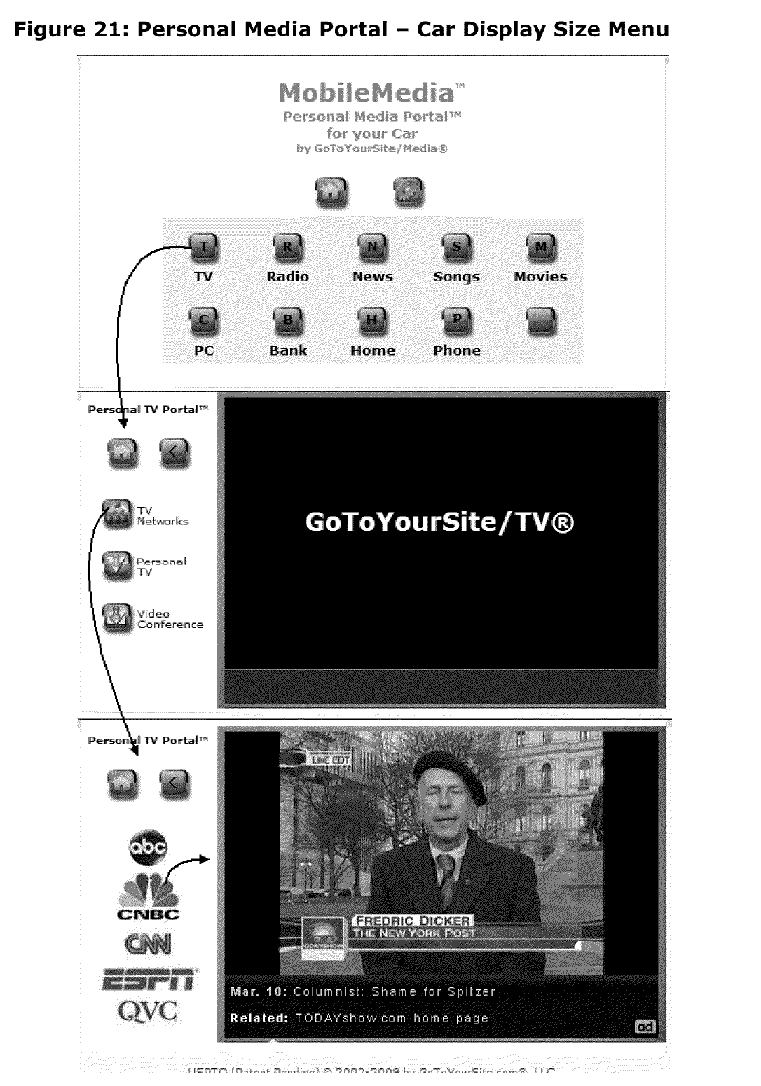

FIG. 22 is a screen shot of the personal media portal (CMS computer size) menu options page;

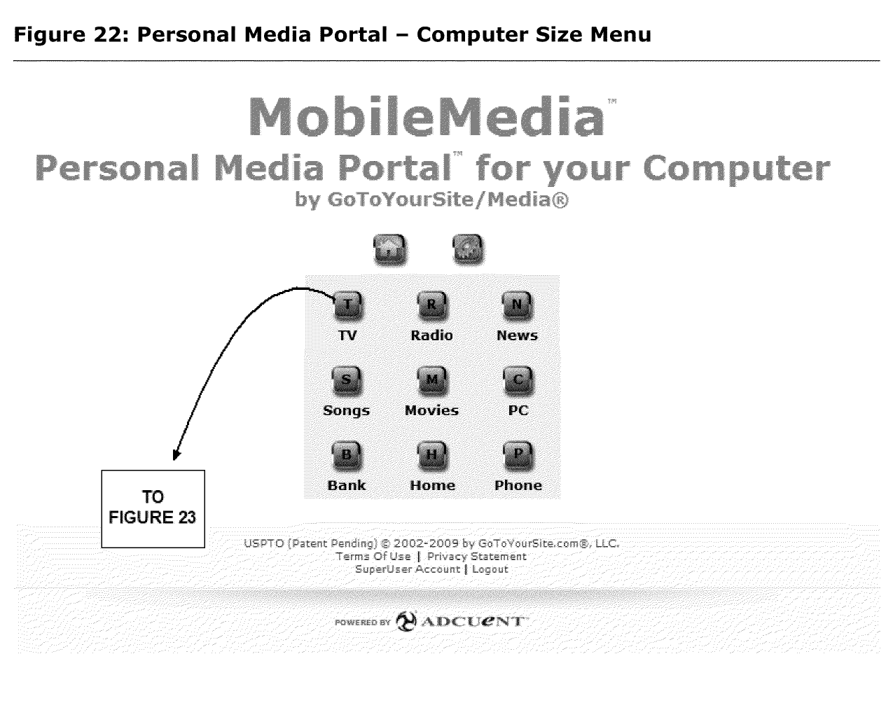

FIG. 23 is a screen shot of the personal media portal (CMS computer size) TV menu options page;

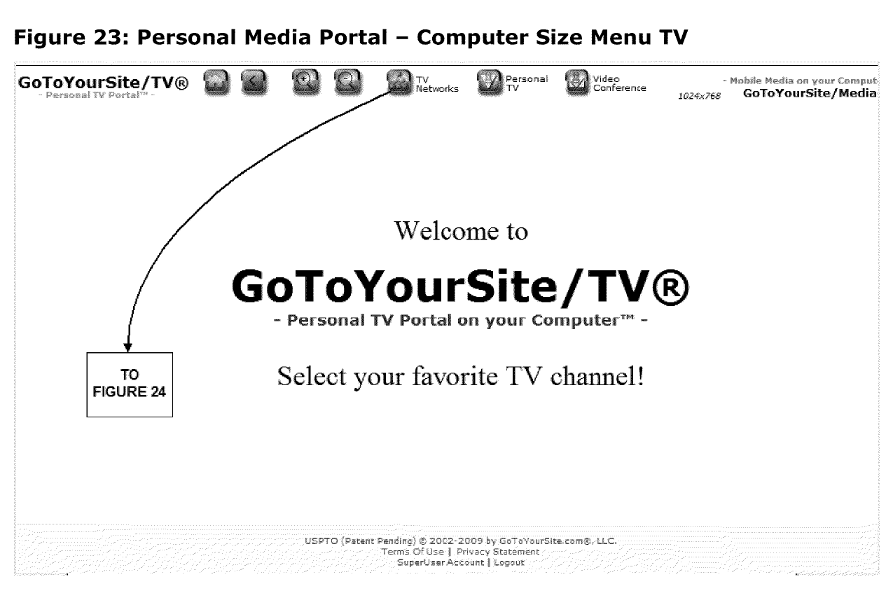

FIG. 24 is a screen shot of the personal media portal (CMS computer size) TV Channel selected content page;

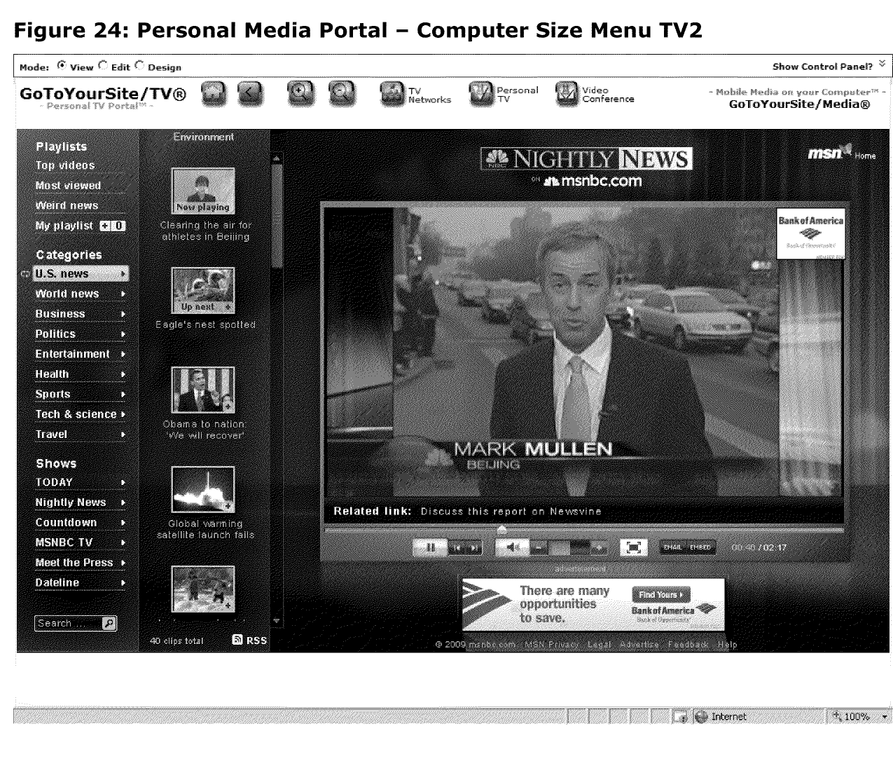

What is claimed is:

1. A group-based system for providing to a Personal Media Group (Media Broadcaster and Media Consumer) of users access to a group website technology development environment (Group Content Management System or GCMS), comprising: A) a plurality of user web browsers devices, user e-mail devices and user text-messaging devices, with each user web browsers devices, user e-mail device and user text-messaging device being associated with a user of the system and with each user being capable of having predefined characteristics indicative of multiple predetermined roles in the system, each role providing a level of access for content (alphanumeric characters and symbols) management and exchange, and to a plurality of data files associated with a particular independent website development environment (Content Management System or CMS) and a level of control over the content (alphanumeric characters and symbols) management and exchange, and data files associated with the independent website development environment (CMS) with the multiple predetermined user roles comprising at least three user's predetermined roles selected from the group consisting of a Consumer role in one or more independent website development environments (CMS) associated with a Consumer user, a Broadcaster role in one or more independent website development environment (CMS) associated with a Broadcaster user and an administrator role associated with an administrator user in one or more independent website development environment (CMS) associated with an administrator role, and B) at least one server computer in communication with each of the user web browser devices (computers sized as: a) Plasma/Flat TV, b) standard size computer, c) car display size computer and d) mobile phone size computer), user e-mail devices and user text-messaging devices over a network, the server computers comprising: means for storing a plurality of content (alphanumeric characters and symbols) and data files associated with an independent website development environment (CMS), means for assigning a level of access to and control of the content (alphanumeric characters and symbols) management and exchange, and each data file based on a user of the system's predetermined role in an independent website development environment (CMS); means for determining whether access to the content (alphanumeric characters and symbols) management and exchange, and to a data file associated with the independent website development environment (CMS) is authorized; means for allowing access to and control of the content (alphanumeric characters and symbols) management and exchange, and a data file associated with the independent website development environment (CMS) if authorization is granted based on the access level of the user of the system.

2. The system of claim 1 wherein the Media Consumer user is provided with an access level to enable the creation and editing of a new and predefined plurality of content (alphanumeric characters and symbols) and data files associated with an independent website development environment (CMS) connected to the system of claim 1 (GCMS), intended only for that particular Media Consumer user and labeled as The Personal Media Portal. Included in the Personal Media Portal (CMS), the storage and interpretation of Media Content (Television, Radio, News Papers, Songs [Music], Movies, PC [Cloud Computer], Home [Virtual Home], Phone [Video Conferencing], etc.), delivered by the Media Broadcaster (Producer and/or Distributor of Media Content).

3. The system of claim 1 wherein the administrator, Media Broadcaster or Media Consumer user is provided with an access level to enable the creation and editing of a plurality of content (alphanumeric characters and symbols) and data files associated with an independent website development environment (CMS) intended for the use as a community for Media Broadcaster users and a community for Media Consumer user (the Broadcaster Community Website [CMS] and the Consumer Community Website [CMS] respectively).

4. The system of claim 2 wherein the independent website development environment (CMS) content (alphanumeric characters and symbols) and data files comprise predefined content (alphanumeric characters and symbols) and data files related to the Media Consumer Personal Media Category, further comprising means for: A Personal Media section for Television Content: A Personal Media section for Radio Content: A Personal Media section for News Papers Content: A Personal Media section for Songs [Music] Content: A Personal Media section for Movies Content: A Personal Media section for PC [Cloud Computer] Content: A Personal Media section for Home [Virtual Home] Content: A Personal Media section for Phone [Video Conferencing] Content: A Personal Media section for User Defined Media Content.

5. The system of claim 2 wherein the independent website development environment (CMS) content (alphanumeric characters and symbols) and data files comprise predefined content (alphanumeric characters and symbols) and data files related to the Media Consumer media device, further comprising means for: A Personal Media Portal that fits on a Plasma/Flat TV Size web browser device (for use at home), A Personal Media Portal that fits on a Computer Size web browser device (for use in the computer workstation, laptop, notebook or net-book), A Personal Media Portal that fits on a Car Display Size web browser device (for use in the car), A Personal Media Portal that fits on a Phone Size web browser device (for use in the phone).

6. The system of claim 2 wherein the independent website development environment (CMS) content (alphanumeric characters and symbols) and data files comprise predefined content (alphanumeric characters and symbols) and data files related to the Media Consumer's Personal Media Portal Configuration and Set Up.

7. The system of claim 2 wherein the independent website development environment (CMS) content (alphanumeric characters and symbols) and data files comprise predefined content (alphanumeric characters and symbols) and data files related to the Media Consumer's Personal Media Portal personal media group communication (GCMS Communication), further comprising means for: A Media Content Update Repository Section: A Notification System Content Repository Section: A Advertisement Content Repository Section.

8. The system of claim 3 wherein the independent website development environment (CMS) content (alphanumeric characters and symbols) and data files comprise predefined content (alphanumeric characters and symbols) and data files related to the Media Broadcaster or Media Consumer community user's Community Forums.

9. The system of claim 3 wherein the independent website development environment (CMS) content (alphanumeric characters and symbols) and data files comprise predefined content (alphanumeric characters and symbols) and data files related to the Media Broadcaster or Media Consumer community user's Community Blogs.

10. The system of claim 3 wherein the independent website development environment (CMS) content (alphanumeric characters and symbols) and data files comprise predefined content (alphanumeric characters and symbols) and data files related to the Media Broadcaster or Media Consumer community user's Community Marketplace.

11. The system of claim 3 wherein the independent website development environment (CMS) content (alphanumeric characters and symbols) and data files comprise predefined content (alphanumeric characters and symbols) and data files related to the Media Broadcaster or Media Consumer community user's Community Support.

12. The system of claim 3 wherein the independent website development environment (CMS) content (alphanumeric characters and symbols) and data files comprise predefined content (alphanumeric characters and symbols) and data files related to the Media Broadcaster or Media Consumer community user's Community Video-Training.

13. The system of claim 3 wherein the independent website development environment (CMS) content (alphanumeric characters and symbols) and data files comprise predefined content (alphanumeric characters and symbols) and data files related to the Media Broadcaster or Media Consumer community user's Community User Registration to use the system of claim 1 (or GCMS).

14. The system of claim 3 wherein the independent website development environment (CMS) content (alphanumeric characters and symbols) and data files comprise predefined content (alphanumeric characters and symbols) and data files related to the Media Broadcaster or Media Consumer community user's Community Payment Processing/eCommerce to use the system of claim 1 (or GCMS).

15. The system of claim 3 wherein the independent website development environment (CMS) content (alphanumeric characters and symbols) and data files comprise predefined content (alphanumeric characters and symbols) and data files related to the Media Broadcaster or Media Consumer community user's Community User Defined Section.

16. The system of claim 3 wherein the independent website development environment (CMS) content (alphanumeric characters and symbols) and data files comprise predefined content (alphanumeric characters and symbols) and data files related to the community Personal Media Group Communication (GCMS Communication), further comprising means for: A Media Content Update System Section: A Notification System Administration Section: A Advertisement System Section.

17. The system of claim 3 wherein the independent website development environment (CMS) content (alphanumeric characters and symbols) and data files comprise predefined content (alphanumeric characters and symbols) and data files related to the community Personal Media Group generation, further comprising means for: A Personal Media Group Account (Admin) Enrollment Section: A Media Benefactor Account Enrollment Section: A Media Consumer Account Enrollment Section: A Personal Media Portal (CMS) Generation Section.

18. The system of claim 3 wherein the independent website development environment (CMS) content (alphanumeric characters and symbols) and data files comprise predefined content (alphanumeric characters and symbols) and data files related to the community Personal Media Group (GCMS) Reports, further comprising means for: A Report for all Media Broadcasters and Consumers Accounts and Personal Media Portals (CMSs) links.

19. The system of claim 2 and 3 wherein the independent website development environment (CMS) content (alphanumeric characters and symbols) and data files comprise predefined content (alphanumeric characters and symbols) and data files related to the Control Panel function for content management and administration, further comprising means for: A Mode Selection function section including View, Edit and Design: A Page function section including Add, Settings, Delete, Copy, Export and Import: A Module Management function section including Add New Module, Add Existing Module and Install Additional Modules: A Common Tasks function section including Site, Users, Roles, Files, Help and Solution Explorer.

20. The system of claim 2 and 3 wherein the independent website development (CMS) environment content (alphanumeric characters and symbols) and data files comprise predefined content (alphanumeric characters and symbols) and data files related to the Website Environment to be divided in Pages (accessible by Menu Options or URL Links) and each Page subsequently divided in Panes (capable of storing Modules) with a look and feel predefined by Templates (or Skins).

21. The system of claim 2 and 3 wherein the independent website development (CMS) environment content (alphanumeric characters and symbols) and data files comprise predefined content (alphanumeric characters and symbols) and data files related to User-Defined Menu Options and Pages.

22. The system of claim 2 and 3 wherein the independent website development environment (CMS) content (alphanumeric characters and symbols) and data files comprise predefined content (alphanumeric characters and symbols) and data files related to Module Management, further comprising means for: A Blog module: A Forum module: A Announcements module: A Latest News module: A Banners module: A Slide Show module: A eCommerce module: A Audio file player module: A Video file player module: A Events module: A FAQs—Frequently Asked Questions module: A Feed Explorer module: A Form Master module: A Google Addsense module: A Help module: A Links module: A Marketshare module: A Media module: A News Feeds (RSS) module: A Reports module: A Repository module: A Search input/results module: A Survey module: A TXT/HTML module: A XML/XSL module: A User Defined Tables module: A Users Online module: A Wiki module: A Feedback Email Communication module: A User Registration Forms module: A Data Capture Forms module: A IFrame module: A Map module.

23. The system of claim 2 and 3 wherein the independent website development environment (CMS) content (alphanumeric characters and symbols) and data files comprise predefined content (alphanumeric characters and symbols) and data files related to the Social Networking module, further comprising means for: A User Event Administrator Section: A User Profile Administrator Section: A User Group Administrator Section: A User Wall Administrator Section: A User Referrals Administrator Section: A User Defined Feature Section.

24. The system of claim 2 and 3 wherein the independent website development environment (CMS) content (alphanumeric characters and symbols) and data files comprise predefined content (alphanumeric characters and symbols) and data files related to the independent website development environment (CMS) administration, further comprising means for: A Website Settings Administration Section: A Page Administration Section: A Security Roles Administration Section: A User Account Administration Section: A Vendor Administration Section: A Website Log Administration Section: A Newsletter Administration Section: A File Manager Administration Section: A Recycle Bin Administration Section: An Event Viewer Administration Section: A Template (Skins) Administration Section, A Language-Set Administration Section: A Site Wizard Administration Section: An Authentication Administration Section: A Solution Explorer Administration Section: A Whats New Section: A User Defined Function Section: A Supper User (Host) Setting section: A Portal Administration Section: A Module Definitions section: A Supper User (Host) File Manager section: A SQL Script Execution section: A Schedule Administration Section: A Search Administration section: A List Administration Section: A Supper User (Host) Account Administration section: A User-Defined Module/Skin-Container Administration section.

25. The system of claim 2 and 3 wherein the independent website development environment (CMS) content (alphanumeric characters and symbols) and data files comprise predefined content (alphanumeric characters and symbols) and data files related to the independent website development environment (CMS) SSL Certificate System, further comprising the means for: An Encrypted Communication between the internet browser used by each of the user computers over a network to connect to the server computer hosting the independent website development environment content (alphanumeric characters and symbols) and data files.

26. The system of claim 2 and 3 wherein the independent website development environment (CMS) content (alphanumeric characters and symbols) and data files comprise predefined content (alphanumeric characters and symbols) and data files related to the independent website development environment (CMS) Domain Name, further comprising the means for: A Domain Name registration to be used by the internet browser of each of the user computers over a network to connect to the server computer to reach and access the independent website development environment content (alphanumeric characters and symbols) and data files.

27. The system of claim 2 and 3 wherein the independent website development environment (CMS) content (alphanumeric characters and symbols) and data files comprise predefined content (alphanumeric characters and symbols) and data files related to the independent website development environment (CMS) Reachable by Search Engines, further comprising the means for: A Keywords Repository Section to be read by any search engine (Google, Yahoo, Microsoft, etc) so a search user can find the independent website development environment content (alphanumeric characters and symbols) and data files.

28. A method for providing Personal Media Group (GCMS) content management and exchange method for a community of users in a network based system comprising the steps of: A). establishing that each user is capable of having redefined characteristics indicative of multiple predetermined roles in the system and each role providing a level of access to and control of a plurality of independent website development environment content (alphanumeric characters and symbols) and data files, e-mail device and text-messaging device; B). establishing a group website development environment (GCMS) to be offered, comprising i. generating the Personal Media Group (GCMS) composed by a set of independent website development environments (CMS) content (alphanumeric characters and symbols) and data files for use with creating the Personal Media Broadcaster Community Website (CMS), the Personal Media Consumer Community Website (CMS), the Consumer's Personal Media Portal (CMS) Template, a Personal Media Portal (CMS) for each Consumer user, e-mail device and text-messaging device for each user; ii. establishing the relationships in the Personal Media Group (GCMS) composed by the relationship between a user and his/her independent website development environment (CMS) content (alphanumeric characters and symbols) and data files, e-mail device and text-messaging device; iii. establishing the communication channel in the Personal Media Group (GCMS) composed by the communication between two or more independent website development environments (CMSs) content (alphanumeric characters and symbols) and data files, e-mail device and text-messaging device; iv. transferring the Personal Media Group (GCMS) composed by the independent website development environments (CMS) content (alphanumeric characters and symbols) and data files, e-mail device and text-messaging device to a server computer for storage; and v. allowing access to and control of the Personal Media Group (GCMS) composed by the independent website development environments (CMSs) content (alphanumeric characters and symbols) and data files, e-mail device and text-messaging device according to the established roles for the users according to step (A); C). providing a predetermined level of access and control over the network to the Personal Media Group (GCMS) composed by a group of independent website development environment (CMS) content (alphanumeric characters and symbols) and data files, e-mail device and text-messaging device to users with an established role as a Broadcaster, Consumer or other user enrolled in the group website development environment (GCMS).

29. The method of claim 28 wherein at least one of the independent website development environments (CMS) content (alphanumeric characters and symbols) and data files comprises a Media Content generation method, further comprising the steps of: D) the media content generator user (Broadcaster user) creating a communication channel content (alphanumeric characters and symbols) and data files for the media content generation method; E) the media content generator user (Broadcaster user) creating the media content (alphanumeric characters and symbols) and data files; and F) the media content generator user (Broadcaster user) transferring the media content (alphanumeric characters and symbols) and data files from the media content generator user's (Broadcaster user) computer to the server computer.

30. The method of claim 28 wherein at least one of the independent website development environments (CMS) content (alphanumeric characters and symbols) and data files, e-mail device and text-messaging device comprises a Media Content receiver and interpreter method, further comprising the steps of: G) the media content receiver and interpreter user (Consumer user) accessing the media content generator user's (Broadcaster user) media content (alphanumeric characters and symbols) and data files by creating a communication channel content (alphanumeric characters and symbols) and data files for the media content receiver and interpreter method; H) the media content receiver and interpreter user (Consumer user) transferring the media content generator user's (Broadcaster user) media content (alphanumeric characters and symbols) and data files from the server computer to the media content receiver and interpreter user's (Consumer user) web browser device (Plasma/Flat TV Size, Computer Size, Car Display Size or Mobile Phone Size) and/or e-mail device and/or text-messaging device; and I) the media content receiver and interpreter user (Consumer user) receiving and interpreting the media content generator user's (Broadcaster user) media content (alphanumeric characters and symbols) and data files to determine an action to take, an event to happen, etc. established by the media content generator user (Broadcaster user).

31. The method of claim 28 wherein at least one of the independent website development environments (CMS) content (alphanumeric characters and symbols) and data files comprises a notification generation method, further comprising the steps of: J) the notification generator user (Broadcaster user) creating a notification message content (alphanumeric characters and symbols) for the notification generation method; K) the notification generator user (Broadcaster user) transferring the notification message content (alphanumeric characters and symbols) from the notification generator user's (Broadcaster user) computer to the server computers for the notification generation method; L) the notification message posting user (Broadcaster user) posting the notification message content (alphanumeric characters and symbols) for transition to the notification message user recipients based on the parameters selected in the creation of the notification.

32. The method of claim 28 wherein at least one of the independent website development environments (CMS) content (alphanumeric characters and symbols) and data files comprises a notification recipient method, further comprising the steps of: M) the notification message recipient user (Consumer user) transferring the notification message content (alphanumeric characters and symbols) from the server computer to the notification message recipient user's (Consumer user) web browser device (Plasma/Flat TV Size, Computer Size, Car Display Size, Mobile Phone Size).

33. The method of claim 28 wherein at least one of the user's e-mail devices comprises a notification recipient method, further comprising the steps of: N) the notification message recipient user (Consumer user) transferring the notification message content (alphanumeric characters and symbols) from the server computer to the notification message recipient user's (Consumer user) e-mail device such as a computer, laptop computer.

34. The method of claim 28 wherein at least one of the user's text-messaging devices comprises a notification recipient method, further comprising the steps of: O) the notification message recipient user (Consumer user) transferring the notification message content (alphanumeric characters and symbols) from the server computer to the notification message recipient user's (Consumer user) text-messaging device such as a cell-phone, PDA, mobile device, etc.

35. The method of claim 28 wherein at least one of the independent website development environments (CMS) content (alphanumeric characters and symbols) and data files comprises a Personal Media Group (GCMS) management method, further comprising the steps of: P) the administrator user connecting the Personal Media Portal or independent website development environment (CMS) content (alphanumeric characters and symbols) and data files to the Personal Media Group (GCMS) for the Personal Media Group management method; Q) the administrator user disconnecting the Personal Media Portal or independent website development environment (CMS) content (alphanumeric characters and symbols) and data files from the Personal Media Group (GCMS) for the Personal Media Group management method.

36. The method of claim 28 wherein the communication channel content (alphanumeric characters and symbols) and data files comprises a multi-directional communication channel method within the Personal Media Group (GCMS), further comprising the steps of: R) the Broadcaster user or administrator user, creating a communication channel content (alphanumeric characters and symbols) and data files to establish a communication direction from the Personal Media Group Broadcasters Community Website (CMS) to the Consumer's Community Website (CMS); S) the Consumer user, creating a communication channel content (alphanumeric characters and symbols) and data files to establish a communication direction from the Consumer Community Website (CMS) to the Consumer's Personal Media Portal (CMS) for the communication channel method.

37. The method of claim 28 wherein at least one of the independent website development environments (CMS) content (alphanumeric characters and symbols) and data files comprises a advertisement generation method, further comprising the steps of: T) the advertisement generator user (administrator user) creating a advertisement content (alphanumeric characters and symbols) and data files for the advertisement generation method; U) the advertisement generator user (administrator user) transferring the advertisement content URL location (alphanumeric characters and symbols) from the advertisement generator user's (administrator user) computer to the server computers for the advertisement generation method; V) the advertisement posting scheduler user (administrator user) updating the advertisement content URL location (alphanumeric characters and symbols) on the advertisement section of the independent website development environment (CMS) associated with the Consumer's Personal media Portal.

38. The method of claim 28 wherein at least one of the independent website development environments (CMS) content (alphanumeric characters and symbols) and data files comprises a advertisement recipient method, further comprising the steps of: X) the advertisement recipient user (Consumer user) transferring the advertisement content (alphanumeric characters and symbols) and data files from the Personal Media Portal (CMS) server computer to the advertisement recipient user's (Consumer user) web browser device (Plasma/Flat TV Size, Computer Size, Car Display Size and Mobile Phone Size).

39. The method of claim 28 wherein the individual website development environments (CMSs) content (alphanumeric characters and symbols) and data files comprises a domain name registration method, further comprising the steps of: Y) the admin user creating all domain names for all Consumers's Personal Media Portals (CMSs) following a naming convention (e.g.: FirstNameLastName.tv or .name or .net) and registering them with the ICAN entity.
